(19) United States
(12) Patent Application Publication
(10) Pub. No.: US 2003/0027611 A1
(43) Pub. Date: Feb. 6, 2003

(54) Three interrelated games

(76) Inventor: Richard H. Recard JR., Louisville, CO (US)

Correspondence Address: Richard H. Recard, Jr., P.O. Box 4082, Boulder, CO, 80306-4082, US

(21) Appl. No.: 09/827,844

(22) Filed: Apr. 6, 2001

(51) Int. Cl. G06F 19/00

(52) U.S. Cl. 463/1

(57) ABSTRACT

Three interrelated games, sharing elements of their spacecraft navigation components consisting of game boards, game markers, and rules articulating spacecraft game marker movement to game board polygons and figures; wherein one game simulates a stellar civilization's economic development subsumed by a universal moral or karmic dynamic analogous to natural law, generating a synergy between each player's advancement of their own economic interests and their sacrifices for the advancements of other players, using a non-tessellating game board and incorporating a population homeostasis mechanism; and wherein the remaining two games are more fundamentally interrelated by their simulations of sports-like competition—one using a tessellating and the other a non-tessellating game board—between fleets of spacecraft which attempt to remove each other from play using laser registers upon hull photo-receptor targets while concurrently attempting to circumnavigate a star to gain points which are exchanged for spacecraft differentiated by power. All games include hypertime and/or hyperspace mechanisms which simulate transcending time and space. Also developed are the essential features of the three games' implementations using software distributed upon computer networks and interacting real-time thereon.

### BACKGROUND OF THE INVENTION

A. Field of the Invention

The invention relates to board games and computer implementations of board games which simulate spacecraft navigation of stellar planetary gravitational fields for the purposes of either

(1) economic development of planetary societies subsumed by a moral dynamic in one game variety or

(2) sports-like competition between spacecraft in a second game variety.

B. Prior Art

Predecessor to the present three inventions is U.S. Pat. No. 5,906,372, and preceding patents to that predecessor were U.S. Pat. No. 4,157,184 and Des. Pat. No. 247,453. That predecessor patent was subject to U.S. Provisional Patent Application Ser. No. 60/021,604, and essential features of the present invention not included in the predecessor were disclosed therein. In addition, the two present inventions not having tessellating game boards are related to preceding patents Des. Pat. Nos. 250,053 and 252,049. All of these predecessor and preceding patents were awarded to the present inventor. Therefore, games preexisting and sharing features with the present three inventions belong either to the set of specified utility and design patents awarded to the present inventor or they belong to another set. The following discussion partitions comparisons of the present three inventions first with that other set, not associated with the present inventor and henceforth named the “other inventor game set”, and secondly with the specified set of utility and design patents awarded to the present inventor.

The present three inventions are distinguished between themselves by each's unique combination of three features taken from a set of six fundamental features: sport-like competition, spacecraft navigation, economic competition, moral dynamic, and tessellating versus non-tessellating game board. No one of those three present inventions shares more than two of those features with any one preexisting game belonging to the “other inventor game set.” The paragraphs immediately following describe for specific games belonging to the “other inventor game set” features having apparent resemblance to one or more, considered individually and in combination, of the present inventions' aforementioned “six fundamental features”. However, in every such case of a feature having apparent resemblance, that feature also belongs to the predecessor U.S. Pat. No. 5,906,372, and in that predecessor patent's Prior Art section such apparent resemblances are demonstrated to largely vanish when investigated in detail. Rather than duplicate herein those prior investigations their conclusions are instead reiterated.

The field of tessellating game boards includes three recent patents whose tessellating features approach to varying degree in their intent the tessellating feature of the present invention's StarWorlds Galactic game: O'Conner's 1986 “Interchangeable Game Board”, U.S. Pat. No. 4,614,344, Saiz's 1994 “Board for the Playing of Multiple Board Games”, U.S. Pat. No. 5,303,930, and Somerville's 1989 “Game Board”, U.S. Pat. No. 4,828,268. However, it was demonstrated in U.S. Pat. No. 5,906,372 that none of those three establish precedent to that predecessor patent. And since StarWorlds Galactic inherits its tessellation feature from that predecessor patent, none of those three patents belonging to the “other inventor game set” established precedent to StarWorlds Galactic.

The present invention's UniStar Synergy game simulates in part a moral dynamic between players, but games belonging to the “other inventor game set” realizing moral themes, whether instructional or dynamic, are rare compared to strategy games. They include Neff's 1982 “Board Game With Interrelated Cards and Chips”, U.S. Pat. No. 4,359,226, Masakayan's 1996 “Good News Bible Board Game”, U.S. Pat. No. 5,529,308, and Munn et al.'s 1983 “Conquest Game”, U.S. Pat. No. 4,385,765. However, it was demonstrated in U.S. Pat. No. 5,906,372 that none of those three established precedent to that predecessor patent. And since UniStar Synergy inherits its moral dynamic feature from that predecessor patent, none of those three patents belonging to the “other inventor game set” established precedent to UniStar Synergy.

The present invention's UniStar Synergy simulates in part economic competition, and games belonging to the “other inventor game set” realizing economic competition are abundant. However, UniStar Synergy also simulates spacecraft navigation, and games combining themes of economic competition and spacecraft navigation are rare. They include Tourville's 1986 “Board Game”, U.S. Pat. No. 4,570,939. However, U.S. Pat. No. 5,906,372 demonstrates that Tourville's patent established no precedent to it. And since UniStar Synergy inherits its economic feature and many of its spacecraft navigation features from that predecessor patent, Tourville's patent established no precedent to UniStar Synergy.

The present invention's StarWorlds Galactic and UniStar Galactic simulate sports-like competition between spacecraft, which theme finds no representation among games belonging to the “other inventor game set” that also model spacecraft maneuvers.

Finally, comparison must be made between the present three inventions and the present inventor's set of utility and design patents: U.S. Pat. Nos. 5,906,372 and 4,157,184 and Des. Pat. Nos. 247,453, 250,053 and 252,049. The games described in U.S. Pat. Nos. 5,906,372 and 4,157,184 were named therein StarWorlds Synergy and Galactiad respectively, and henceforth those names will be used.

The present invention's StarWorlds Galactic shares its navigation component, described in the following Description of Preferred Embodiments, with StarWorlds Synergy. However, the former simulates a spacecraft space-race competition and the latter simulates economic competition subsumed by a moral dynamic, with respective distinct game markers and rules, and thereby the two games are differentiated. StarWorlds Galactic shares with Galactiad the simulation of a spacecraft space-race competition and shares many of the latter's game markers and rules, but the former's navigation component is distinct from that of the latter—most fundamentally in that the former's game board tessellates whereas the latter's does not—and thereby the two games are differentiated. StarWorlds Galactic incorporates a hypertime-jump mechanism and UniStar Synergy incorporates a population homeostasis mechanism, both absent from StarWorlds Synergy and Galactiad. Finally, StarWorlds Galactic, UniStar Galactic, and UniStar Synergy incorporate instructions for interactive, networked computer embodiments, including some instructions for features absent from their physical, three dimensional board game counterparts, and neither StarWorlds Synergy nor Galactiad include comparably detailed instructions for their computer game embodiments.

Des. Pat. Nos. 247,453, 250,053 and 252,049 are for game boards which share with the present three inventions the feature of a plurality of concentric rings of contiguous hexagons tessellated within and between rings. However, in each design patent there are structures or absences of structures both internal and external to those rings,—i.e., at the centers and peripheries of those game boards—which distinguish each from each of the present three inventions' game boards.

### SUMMARY OF THE INVENTION

The object of the invention is to provide intellectually stimulating simulations of

(1) sports-like competition between fleets of spacecraft which maneuver within single or multiple star planetary systems to concurrently

(a) eliminate other spacecraft from play using laser-registers upon hull photo-receptor targets, and

(b) circumnavigate a star, which trajectory gains points which can be exchanged for additional spacecraft, differentiated between classes of increasing potency to laser-register, avoid laser-register, accumulate circuit points, and transcend time using hypertime-jumps,

using either a relatively compact and therefore minimally costly to manufacture game board which does not tessellate with other identical game boards or using a larger and more costly to manufacture game board that does tessellate with identically shaped game boards, which game board is a component of the present inventor's 1996 “Tessellating Board Game”, U.S. Pat. No. 5,906,372, and

(2) the economic development of a single star planetary system in which economic competitors' choices are constrained by a universal moral or karmic dynamic, generating a synergy between each competitor's advancement of their own economic interests and their sacrifices for the advancements of other competitors, which dynamic includes the effects of population homeostasis,

using a compact and therefore minimally costly to manufacture game board, relative to the aforementioned game board, U.S. Pat. No. 5,906,372, which tessellates with identical game boards to simulate multiple star systems.

Also simulated are the sports-like competition's and the economic competition's requirements for plotting spacecraft trajectories in those single or multiple star systems' combined gravitational fields of star and orbiting planets, adjusting spacecraft speed and direction using planetary encounters and fuel decrements, and—in multiple star system competitions—using hyperspace-jumps to transcend distance.

Additionally developed are the essential features of the three games' implementations using software distributed upon computer networks and interacting real-time controlled through graphical human-to-computer interfaces.

### DESCRIPTION OF THE DRAWINGS

FIG. 1 illustrates the game board according to the StarWorlds Galactic embodiment of the present invention.

FIG. 2A illustrates StarWorlds Galactic game board features which establish its ability to project paths from one game board's concentric rings of contiguous polygons to a tessellating game board's concentric rings of contiguous polygons.

FIG. 2B is a sectional view of FIG. 2A that illustrates the innermost four rings and features of the central star figure.

FIG. 3 illustrates three tessellated StarWorlds Galactic game boards, the three rows of regular hexagons their boundary polygons form, and those row's intersection at a common regular polygon.

FIG. 4 illustrates one embodiment of a spacecraft game marker.

FIG. 5A illustrates an easel for displaying spacecraft identity markers, speed markers, fuel markers, circuit markers, resource markers, population markers, Grace markers, and three knowledge category markers.

FIG. 5B illustrates an easel with spacecraft identity markers, speed markers, and fuel markers. Game markers on the lowest easel ledge and in the home station area in front of the array would be circuit markers in the StarWorlds Galactic game embodiment. In that game embodiment the game markers on the array ledges' extreme right side would be absent. In the UniStar Synergy game embodiment the markers on the lowest ledge and in the home station area would be of the resource and population varieties. Game markers on the array ledges' extreme right side would be of the Grace and knowledge category varieties.

FIG. 6A illustrates a spacecraft identity marker of particular class and number.

FIG. 6B illustrates a speed marker of particular magnitude.

FIG. 6C illustrates a fuel marker of particular magnitude.

FIG. 7A illustrates an outer planet marker.

FIG. 7B illustrates a middle planet marker.

FIG. 7C illustrates an inner planet marker.

FIGS. 8A, 8B, and 8C illustrate resource markers of three respective varieties.

FIG. 9 illustrates an external planet marker.

FIG. 10 illustrates a Grace marker.

FIGS. 11A, 11B, and 11C illustrate markers for three knowledge categories occurring at three particular levels.

FIG. 12A illustrates a catastrophe card.

FIGS. 12B and 12C illustrate entropy cards.

FIG. 13A illustrates a StarWorlds Galactic game board with polygons distinguished by indicia.

FIG. 13B is a sectional view of FIG. 13A that illustrates the indicia for polygons forming the innermost four rings.

FIGS. 14A, 14B, 14C, 14D, 14E, and 14F illustrate a group of flat shapes suitable for society markers representing a progression of increasingly complex societies.

FIG. 15 is a diagram from the game rules instructing the positioning of spacecraft markers upon polygons.

FIGS. 16A and 16B are diagrams from the game rules instructing forbidden polygon crossings.

FIG. 17 is a diagram from the game rules instructing spacecraft marker velocity changes resulting from planet marker traversal using positions beginning and ending within an interior game board (intra-board) region.

FIG. 18A is a diagram from the game rules that illustrates star traversal trajectories and the oppositely positioned polygons upon which planet markers commence their rotations.

FIG. 18B is a sectional view of FIG. 18A instructing spacecraft marker traversal of the game board's central star figure.

FIG. 18C is the text occurring in the game rules that explains the enumerations of FIGS. 18A and 18B.

FIG. 19A is a diagram from the game rules instructing the differentiation of circular, parabolic, and paracircular orbits.

FIG. 19B is the text occurring in the game rules that explains the enumeration of FIG. 19A.

FIG. 20A is a diagram from the game rules instructing speed and fuel implications for direction changes in the exterior game board (inter-board) region.

FIG. 20B is the text occurring in the game rules that explains the enumeration of FIG. 20A.

FIG. 21A is a diagram from the game rules instructing multiple game board configuration spacecraft marker velocity changes resulting from planet marker traversal using positions beginning in the inter-board region, subsequently crossing an intra-board heptagon, and ending in either the intra-board or inter-board region.

FIG. 21B is the text occurring in the game rules that explains the enumeration of FIG. 21A.

FIG. 21C is the table occurring in the game rules that compliments the text displayed in FIG. 21B.

FIG. 22 illustrates a hyperspace-jump marker.

FIG. 23 illustrates a home station marker.

FIG. 24 is a diagram from the game rules illustrating for StarWorlds Galactic's triple game board configuration meta-circular and meta-parabolic orbits.

FIG. 25 is a diagram from the game rules illustrating for StarWorlds Galactic's binary game board configuration meta-circular and meta-parabolic orbits.

FIG. 26A illustrates a population marker.

FIG. 26B illustrates a circuit card.

FIG. 27 illustrates a non-enumerated game board according to the UniStar Galactic and UniStar Synergy embodiments of the present invention.

FIG. 28 illustrates a home station marker which tessellates with the outermost ring of contiguous hexagons on the game boards illustrated in FIGS. 27, 29, 30, and 31A,B.

FIG. 29 illustrates a home station marker tessellated with ring 6 and an external planet marker tessellated with ring 6 of the FIG. 27 game board.

FIG. 30 illustrates a game board around which are positioned six hexagonal, quadripartite shapes combining the functions of home station and external planet markers, construed either as removable markers or printed as game board component.

FIG. 31A illustrates an enumerated game board composed of the FIG. 27 game board with polygons distinguished by indicia and six external planet markers tessellated with the outermost hexagon ring.

FIG. 31B is a sectional view of FIG. 31A.

### REFERENCE NUMERAL WORKSHEET

1. star

2. one of twelve star rays

3. innermost hexagon ring: ring 1

4. outermost ring: ring 7

5. one of six equiangularly positioned heptagons

6. one of polygons tessellating a game board side

7. one of the two sides extending to game board edge of a polygon tessellating a game board side

8. game board edge

9. hexagon ring five

10. hexagon ring three

15. one of two congruent, adjacently positioned game boards

16. one of two congruent, adjacently positioned game boards

17. regular hexagon row formed from conjoining polygons tessellating edges of two congruent game boards

18. a third congruent, adjacently positioned game board configured with two others

19. an additional regular hexagon row formed from tessellating two congruent game boards

20. an additional regular hexagon row formed from tessellating two congruent game boards

21. common hexagon formed at intersection of three regular hexagon rows formed from tessellating three congruent game boards

26. spacecraft marker lower region colored to indicate class

27. spacecraft marker upper region colored to indicate player

28. spacecraft marker numeral

31A. array ledge

31B. array ledge

31C. array ledge

31D. array ledge

32A. spacecraft identity marker

32B. spacecraft identity marker

32C. spacecraft identity marker

33. Grace marker

34. speed marker

35. fuel marker

36. circuit markers in UniStar Galactic or any combination of resource and population markers in UniStar Synergy

37A. knowledge marker of class C1

37B. knowledge marker of class C2

37C. knowledge marker of class C3

39. home station area in front of an array

41. color indicating spacecraft marker's class

42. spacecraft marker numeral, distinct for each member of particular class

43. speed marker numeral

44. speed marker color

45. fuel marker numeral

46. fuel marker color

51. outer planet marker color and indicia

52. middle planet marker color and indicia

53. inner planet marker color and indicia

57. first type resource marker color and indicia

58. second type resource marker color and indicia

59. third type resource marker color and indicia

61. external planet marker interior area one

62. external planet marker interior area two

63. external planet marker interior area three

64. external planet marker interior area four

65. Grace marker numeral

66. Grace marker color and indicia

70. category one knowledge marker color and indicia

71. category one knowledge marker numeral

72. category two knowledge marker color and indicia

73. category two knowledge marker numeral

74. category three knowledge marker color and indicia

75. category three knowledge marker numeral

80. natural catastrophe type

81. natural catastrophe severity

82. playing piece type impaired

83. catastrophe impact area within which a playing piece is impaired

84. minimum knowledge category scores required to avoid impairment

85. manner of playing piece impairment

86. area within which presence of competing player impaired playing piece dictates that a decision to not assist results in Grace level loss but a decision to assist results in no Grace level gain

87. area within which presence of competing player impaired playing piece dictates that a decision to assist results in Grace level gain but a decision to not assist results in no Grace level loss

90. entropic failure type

91. playing piece type impaired

92. area within which a playing piece is entropically impaired

95. entropic failure type

96. playing piece type impaired

97. area within which a playing piece is entropically impaired

98. minimum knowledge category scores required to avoid impairment

99. manner of playing piece impairment

100. area within which presence of competing player impaired playing piece dictates that a decision to not assist results in Grace level loss but a decision to assist results in no Grace level gain

101. area within which presence of competing player impaired playing piece dictates that a decision to assist results in Grace level gain but a decision to not assist results in no Grace level loss

105. letter and number indicia on enumerated game board polygons

107. hyper-spacetime jump marker color and indicia

109. home station marker color and indicia

111. population marker color and indicia

115. circuit marker color and indicia

120. hyper-spacetime jump location

121. hyper-spacetime jump location

121. hyper-spacetime jump location

123. hyper-spacetime jump location

125. hexagon ring seven heptagon hosting a rotating home station marker

127. meta-circular orbit

129. meta-parabolic orbit

132. inter-board hexagon hosting a hyperspace-jump marker

133. intra-board hexagon hosting a hyperspace-jump marker

134. intra-board hexagon hosting a hyperspace-jump marker

137. meta-circular orbit

138. meta-parabolic orbit

142. hexagon ring six

143. non-tessellated space between hexagon ring six and game board edge

150. home station marker color and indicia

160. home station marker tessellated with ring six hexagons

163. external planet marker tessellated with hexagon ring six

170. external planet marker playing piece or printed external planet symbol

175. two ring six hexagons tessellated with an external planet marker

180. enumerated game board hexagon indicia

### DESCRIPTION OF THE PREFERRED EMBODIMENTS

The preferred embodiment is three distinct yet interrelated game apparatus, described in the following Sections I, II, and III.

I. The Starworlds Galactic Game

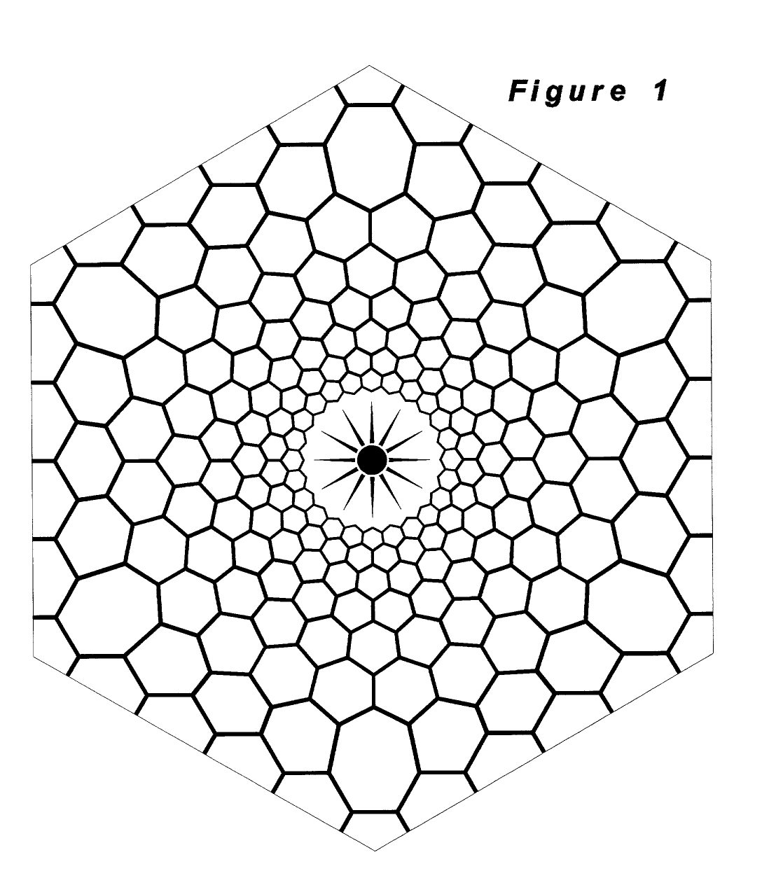

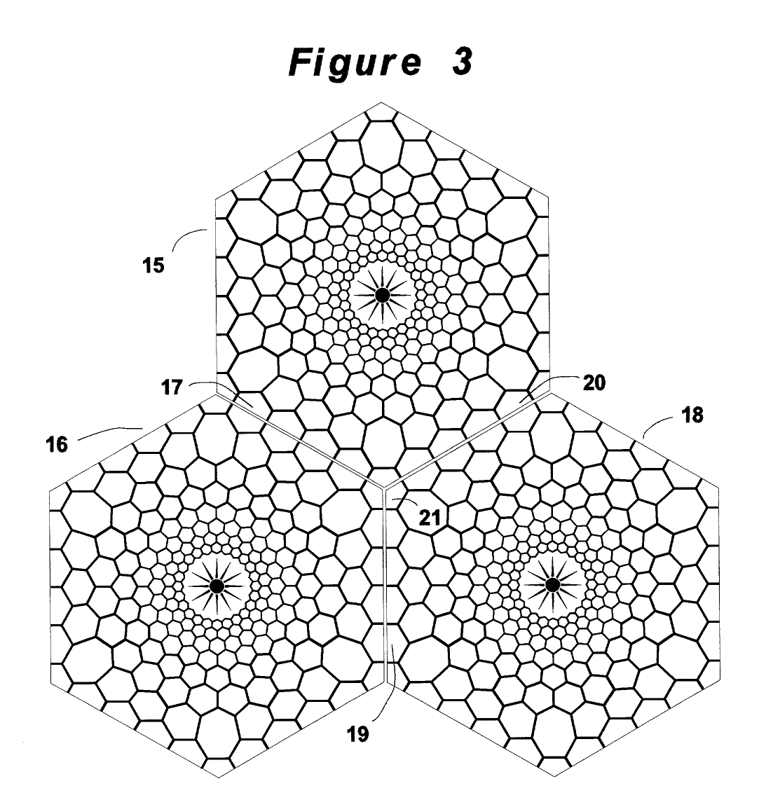

The Starworlds Galactic game simulates Olympic® Games-like competition between multifarious interstellar civilizations whose teams navigate spacecraft in unary, binary, or trinary star planetary systems. A single game board FIG. 1 is used in this embodiment's uni-stellar game version and two or three game boards FIG. 3 are used in its multi-stellar game versions. The competition simulated requires spacecraft to circumnavigate a star to achieve points named circuits, which are exchanged for additional spacecraft, while concurrently attempting to remove adversary spacecraft from play using laser-strikes against adversary hull photo-receptors and avoiding laser-strikes against their own hulls. The laser-strikes are termed registers in game play, and that term will henceforth be used. Spacecraft are differentiated between three classes according to their power to register adversaries, avoid being registered themselves, and accumulate circuit points; and spacecraft circuit point exchange rates increase according to their power class. Players strive, therefore, to maximize their fleets' relative potencies, and that goal's achievement necessitates fleet maneuvers whereby spacecraft constrained by fuel supply transit between varying stellar orbits. A spacecraft remains in any orbit with constant speed without fuel expenditure, but speed increase within an orbit or transit to another orbit with or without speed change requires either fuel expenditure or interaction with a planetary gravitational field. Orbit changing encounters with planets may change or not change speed, and expend no fuel. However, a spacecraft's positioning for a planetary encounter may require fuel use and a spacecraft always expends fuel when changing velocity, i.e., speed and/or direction, without a planetary encounter. Therefore, fuel conservation and replenishment become significant navigation considerations. Spacecraft refuel by traversing an outer planet's exosphere, where they collect magnetically confined high energy particles. Competition winners are determined by either one of two criteria: elimination of all adversary spacecraft from their uni-stellar or multi-stellar arena or achievement of a pre-agreed number of circuit points, incorporated into spacecraft exchange value and not incorporated (existing as circuit markers), by a pre-agreed upon time, measured by planetary rotations.

I.A The Game Board and Its Tessellations With Additional Game Boards

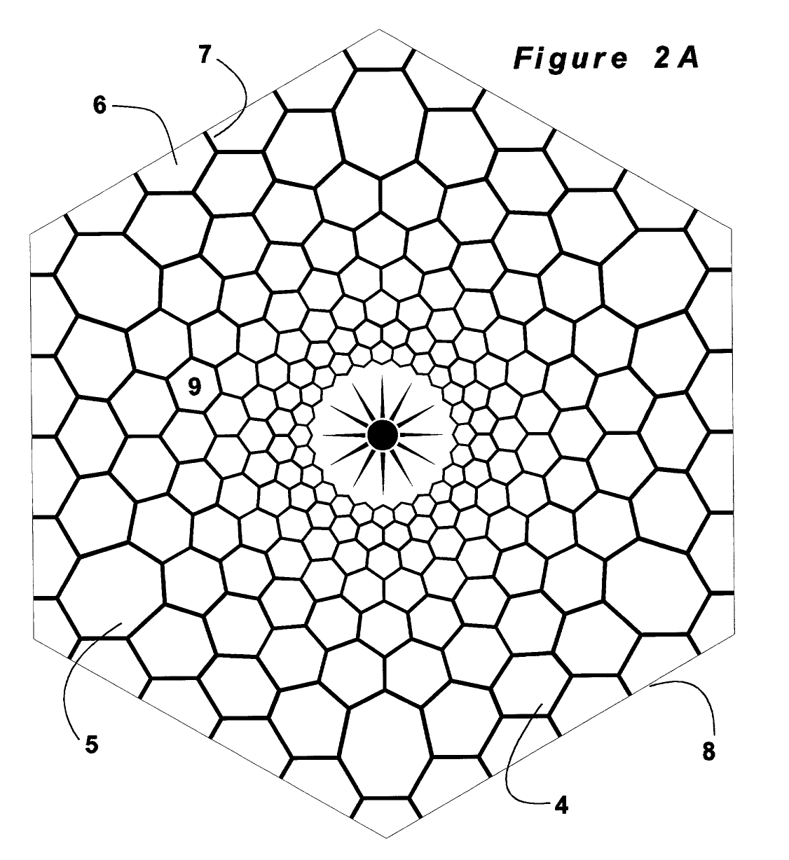

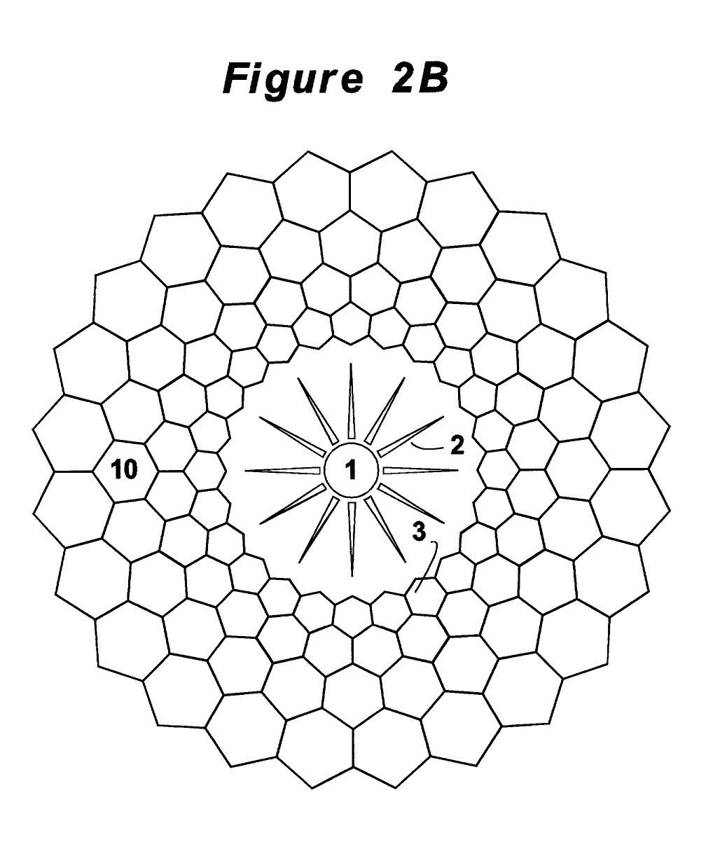

Illustrated in FIG. 1 is the regular hexagon shaped game board. FIGS. 2A,B illustrate its components, comprised of a central figure depicting a star 1 surrounded by rays 2, which star figure's center is the common center of concentric rings of contiguous hexagons—of which 3 is the innermost—the outermost which ring 4 contains six equiangularly positioned heptagons 5, and which outermost ring tessellates with linearly contiguous polygons 6 which tessellate the game board's six sides. The interior and two sides 7 of each said linearly contiguous polygon extend to a game board's edge 8, which edges have no line indicia to demarcate them. This single game board is used in the uni-stellar game version. However, the aforementioned linearly contiguous polygons tessellating the game board's sides are proportioned so that when two congruent game boards FIG. 3-#15,#16 are positioned adjacently (aligning vertex to vertex any side of one to any side of the other), the linearly contiguous polygons of one conjoin with those of the other to form a row of regular hexagons 17. When a third game board 18 is configured with two such that each game board shares an edge with two other game boards that share an edge with each other there is formed two additional rows of regular hexagons 19,20 and the three rows intersect at a common hexagon 21, which is termed a hyperspace-jump location. The three regular hexagon rows form what is termed the inter-board region, simulating interstellar space. The region internal to each game board is termed the intra-board region, simulating the planetary region of a star's gravitational field. Two or more game boards configured as described are used in multi-stellar game versions.

I.B The Spacecraft Markers

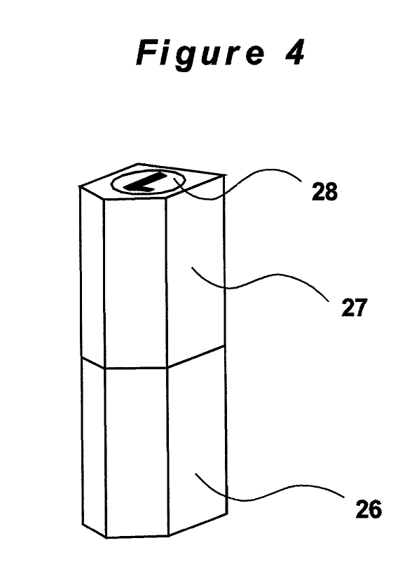

Illustrated in FIG. 4 is one embodiment of the invention's spacecraft marker, composed of lower region 26 colored according to spacecraft class, upper region 27 colored according to spacecraft player, and numeral 28. There are three spacecraft classes—primary, secondary, and tertiary—designated with black, silver, and gold coloring, respectively. The uni-stellar game is played by three or four players, and therefore the spacecraft markers for that game set are differentiated by four distinct player colors. In bi-stellar and tri-stellar games there are respectively six and twelve distinct player colors. In any game, each player receives spacecraft markers consisting of three spacecraft markers of each of the three classes, making nine spacecraft markers the total a player may bring into play. Player spacecraft markers of the same class are distinguished by numerals 1, 2, and 3. For brevity spacecraft markers will henceforth be referred to as spacecraft.

I. C The Array Easel and Its Spacecraft Column

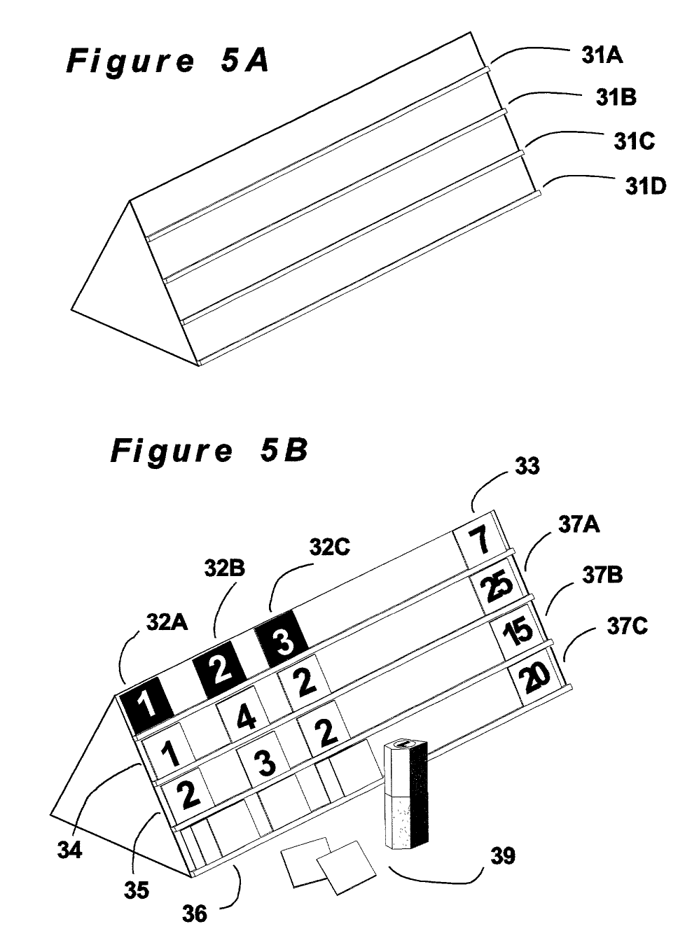

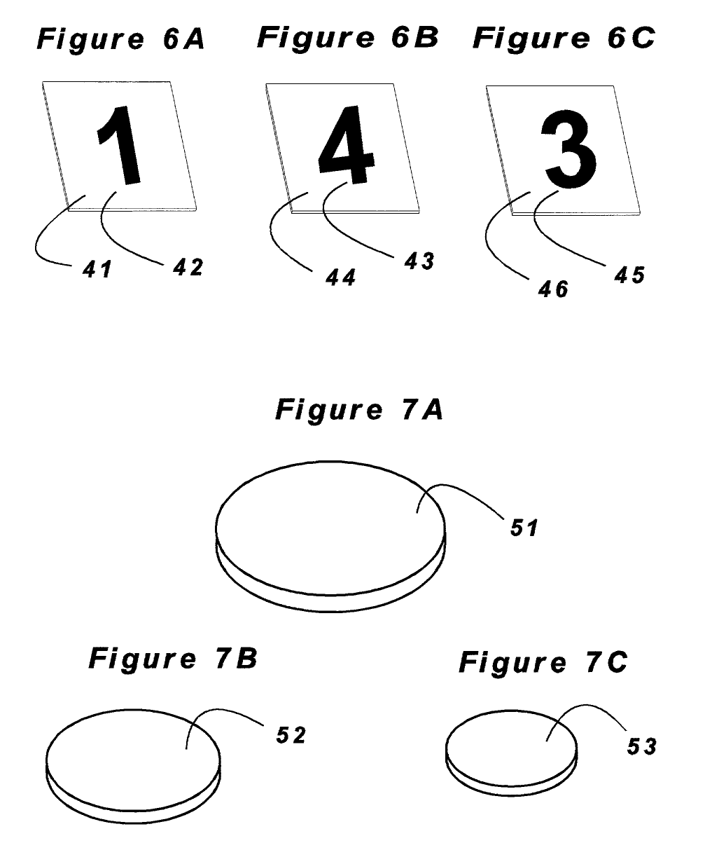

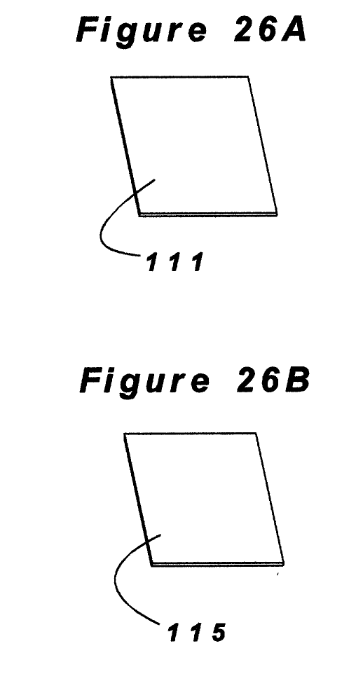

Illustrated in FIG. 5A is an easel, termed in the game rules an array, with four ledges 31A,31B,31C,31D. Each player is distributed an array, whose function is to display for each of that player's spacecraft in play upon the game board a spacecraft identity marker FIG. 6A with the color 41 of that spacecraft's class and the spacecraft's numeral 42, which marker is positioned on the array's topmost ledge 31A. Immediately below the spacecraft identity marker on the array's second ledge 31B is positioned a speed marker FIG. 6B distinguished by numeral 43 and color 44. Immediately below the speed marker on the array's third ledge 31C is positioned a fuel marker FIG. 6C distinguished by numeral 45 and color 46. The array's fourth ledge 31D is reserved for circuit markers FIG. 26B, distinguished by color and indicia 115, each designating one spacecraft traversal of the central star figure. Markers aligned vertically upon the four ledges constitute what is termed a spacecraft column, which identifies for an individual spacecraft its speed, fuel, and number of star traversals.

I.D Example of Configured Array and the Home Station

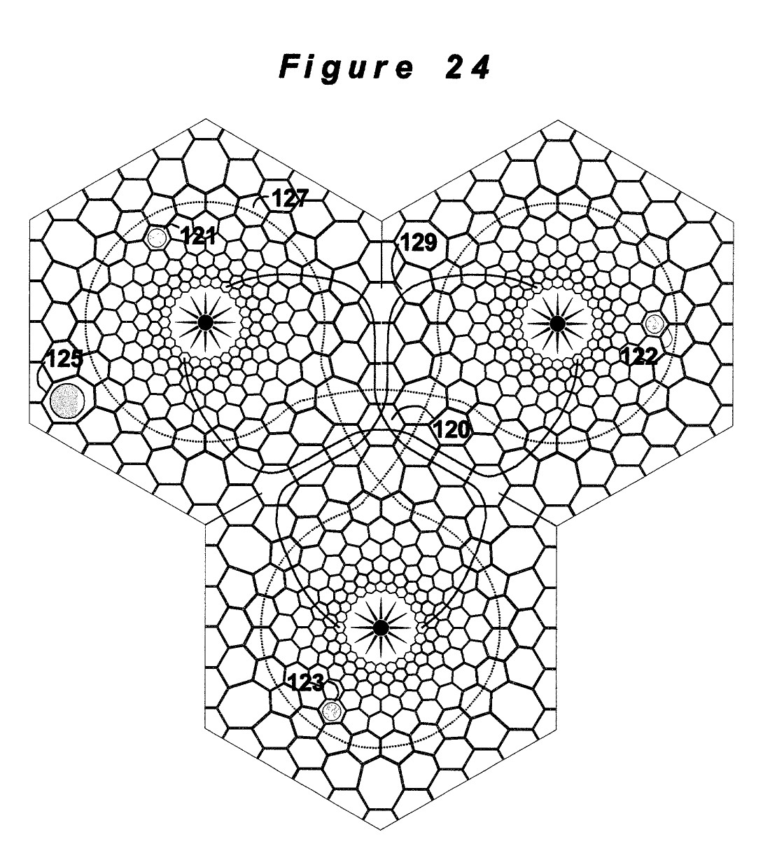

Illustrated in FIG. 5B is an array configured with arbitrarily classed spacecraft identity markers 32A,32B,32C with numerals 1, 2, and 3. Game markers 33, 37A, 37B, and 37C are used in UniStar Synergy, and therefore the array used for StarWorlds Galactic should be conceptualized with those aforesaid markers absent. In the column of the spacecraft identity marker 32A with numeral 1 are speed marker 34 with numeral 1, fuel marker 35 with numeral 2, and three circuit markers 36. Spacecraft identity markers with numerals 2 and 3 also have columns with respective speed, fuel, and circuit markers. The area 39 in front of an array is termed a home station, which is used for the deposit of spacecraft and circuit markers until they are used and which a spacecraft accesses when either, in uni-stellar games, it lands upon the seventh ring heptagon FIG. 2A-#5 its player has selected for that purpose at a game's beginning, designating it their home station heptagon, or, in multi-stellar games, the spacecraft lands upon its home station marker FIG. 23, distinguished by color and indicia 109, that rotates around ring 7 FIG. 24-#125, explained in sections I.F and I.U below. Deposited in the home station depicted 5B-#39 are one spacecraft and two circuit markers.

I.E The Planet Markers

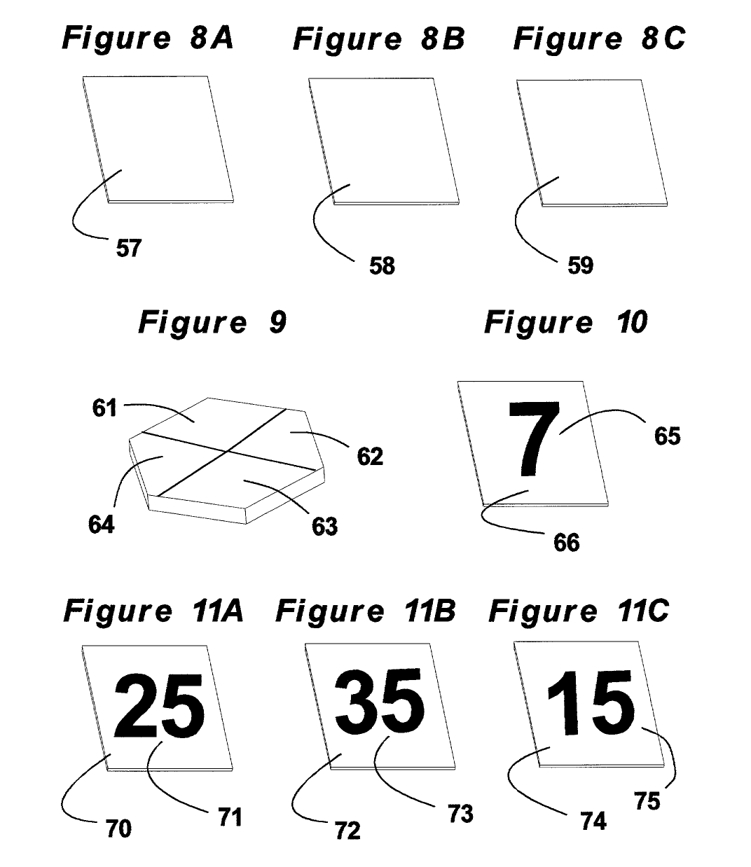

Planet markers are disks FIGS. 7A,7B,7C with diameters varying according to the size of hexagons composing the ring within which each advances, the markers distinguished by their surfaces' color and indicia 51,52,53. Two outer planet markers advance positioned opposite one another in ring 7 FIG. 2A-#4. Two middle planet markers advance positioned opposite one another in ring 5 FIG. 2A-#9, and one inner planet marker advances in ring 3 FIG. 2B-#10. The two outer planet markers are sources of spacecraft fuel.

I.F Circuit Markers, Their Achievement, and Their Conversion to Circuit Points

Circuit markers FIG. 26B are rectangular shaped, scaled to fit on an array ledge, and distinguished by surface color and indicia 115.

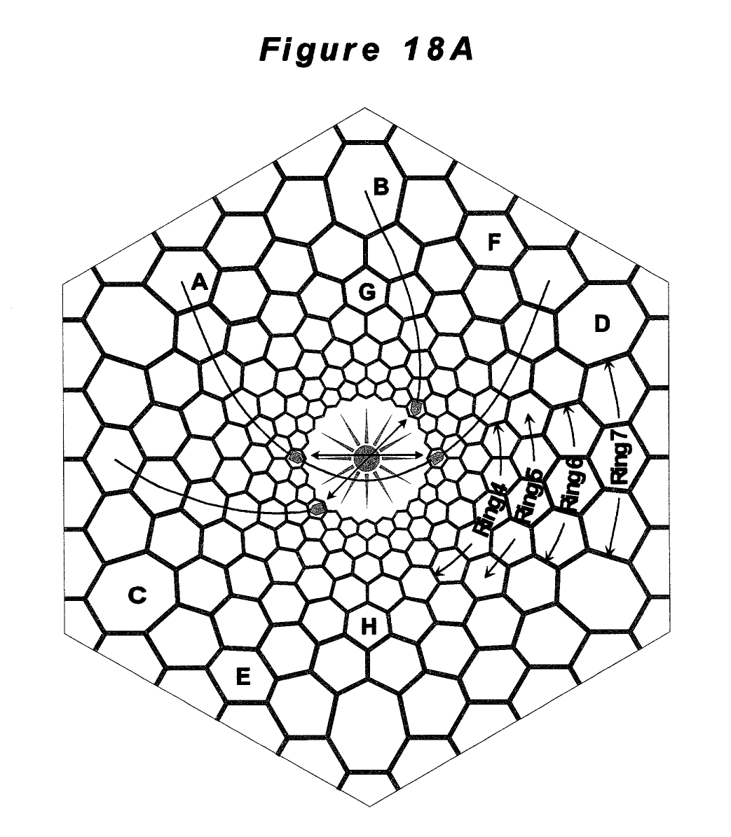

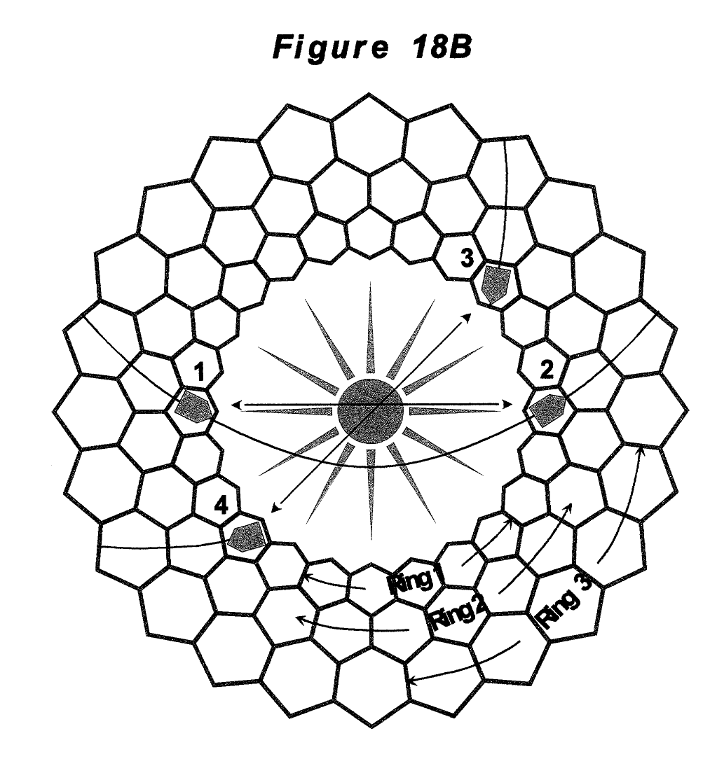

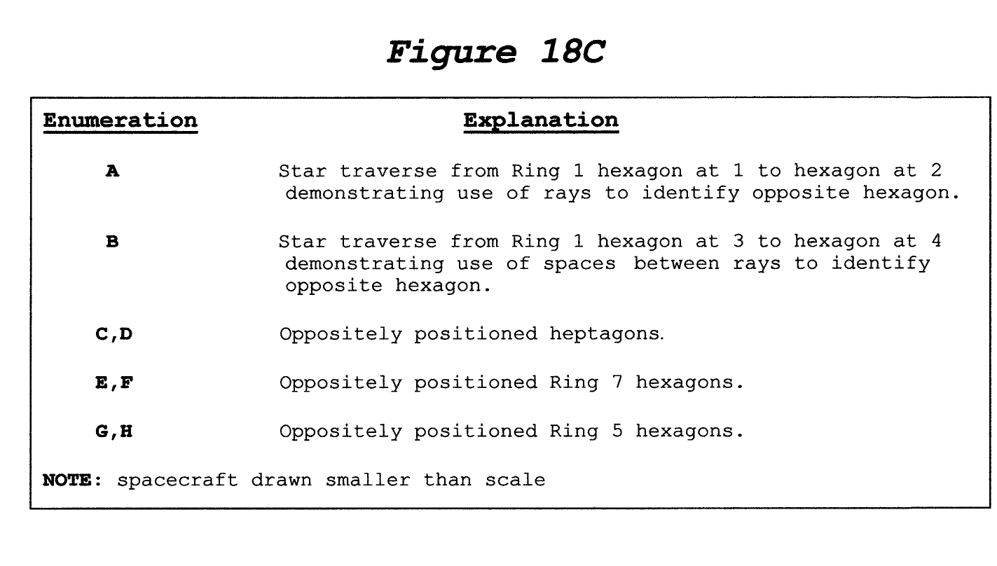

When a spacecraft traverses a game board central star figure and attains a ring one hexagon, demonstrated in FIGS. 18A,B with positions 2 and 4 for traverses A and B respectively, there is placed upon the fourth ledge FIG. 5A-#31D of that spacecraft's array column a circuit marker FIG. 26B, representing one star traversal. When that spacecraft exits the game board at its designated home station heptagon, for uni-stellar games, or home station marker, for multi-stellar games, and attains its home station, that circuit marker is removed from the array and placed in its home station FIG. 5B-#39 (the area in front of the array), thereby becoming one circuit point, the exchange medium, which may be traded for spacecraft. Spacecraft may accumulate in their array columns multiple circuit markers according to their classes' circuit marker transfer capacities, explained in section I.I below.

TABLE 1
Probability That Spacecraft of Class in Columns
Registers Spacecraft of Class in Rows

| | Alpha | | Delta | | Zeta | |
|---|---|---|---|---|---|---|
| | ≦ Sum | P | ≦ Sum | P | ≦ Sum | P |
| Alpha | 14 | 62% | 16 | 75% | 20 | 93% |
| Delta | 9 | 25% | 14 | 62% | 16 | 75% |
| Zeta | 5 | 7% | 9 | 25% | 14 | 62% |

I.G Stochastic Modeling of Spacecraft Registers

The success of one spacecraft's registering another is simulated in Starworlds Galactic by a random function device in conjunction with the frequency distribution it generates. The random function device may be a computer algorithm or one die or the sums of the faces of multiple die. For this embodiment the random function device will be the sums of the faces of four six sided die. Table I demonstrates the use of the cumulative distribution for that sum. The table gives for each possible pairing of spacecraft classes an integer and the probability that four die faces will sum equal to or less than that integer. A player attempting a register tosses four die and sums their face values. Then the player finds the column for their spacecraft's class and the row for the class of the spacecraft he attempts to register. The table cell where the column and row intersect contains the aforementioned integer and probability. If the sum of the player's tossed die is equal to or less than that integer the attempted register succeeds and the registered spacecraft is removed from the game board and cannot return until purchased with circuit points. Any circuit markers the registered spacecraft has in its array column are transferred to the array column of the registering spacecraft, achieving what is designated a pirate register.

I.H Circuit Marker and Fuel Exchanges Between Spacecraft

Circuit markers and fuel may be transferred between any two spacecraft occupying contiguous game board hexagons and having identical velocity (speed and/or direction), using the array mechanism of exchanging circuit markers for increments or decrements of fuel markers. Thus, adversary spacecraft may trade circuit markers for fuel.

I.I The Differentiated Powers of Spacecraft Classes

Spacecraft of primary, secondary, and tertiary classes, the latter being the most powerful, have differentiated capabilities with respect to

(a) registering adversary spacecraft and avoiding being registered,

(b) cargo capacity—primary, secondary and tertiary spacecraft classes being able to transport two, four and six circuit markers respectedly—and

(c) the distance of future times they can visit and from which they can return to present times, which hypertime-jumps are explained in section I.W below.

I.J Spacecraft Exchange Rates

The exchange rate for spacecraft is one circuit point for one primary class spacecraft, two circuit points for one secondary class spacecraft, and three circuit points for one tertiary class spacecraft. Spacecraft may accumulate in their array columns multiple circuit markers before depositing them at their home stations. Spacecraft retain their circuit point exchange value, and may be exchanged alone or in combination with other spacecraft and circuit markers for other spacecraft. Thus, for example, one secondary class spacecraft plus one circuit point may be exchanged for one tertiary class spacecraft.

I.K Initial Playing Pieces Distributions and Configurations

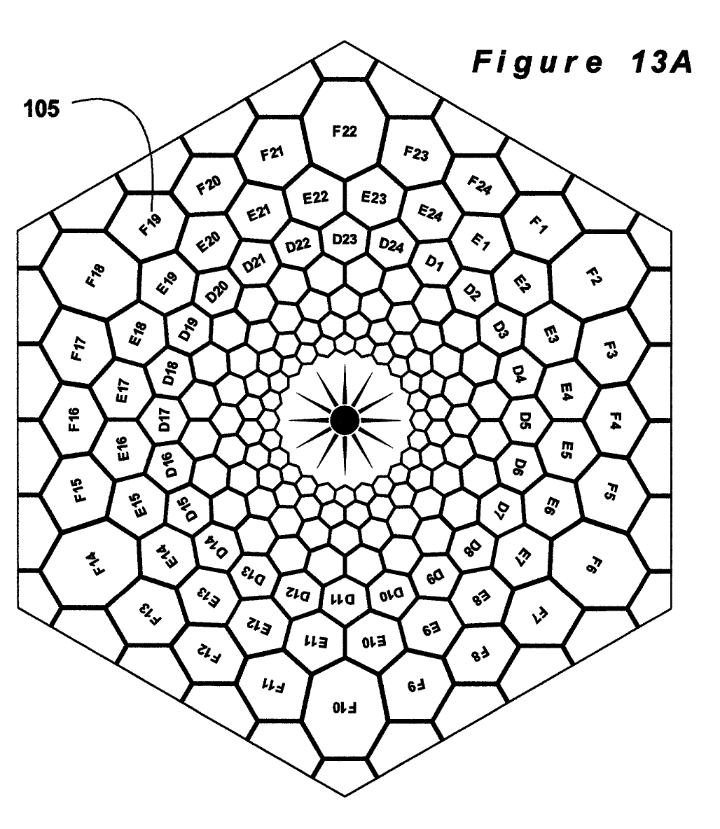

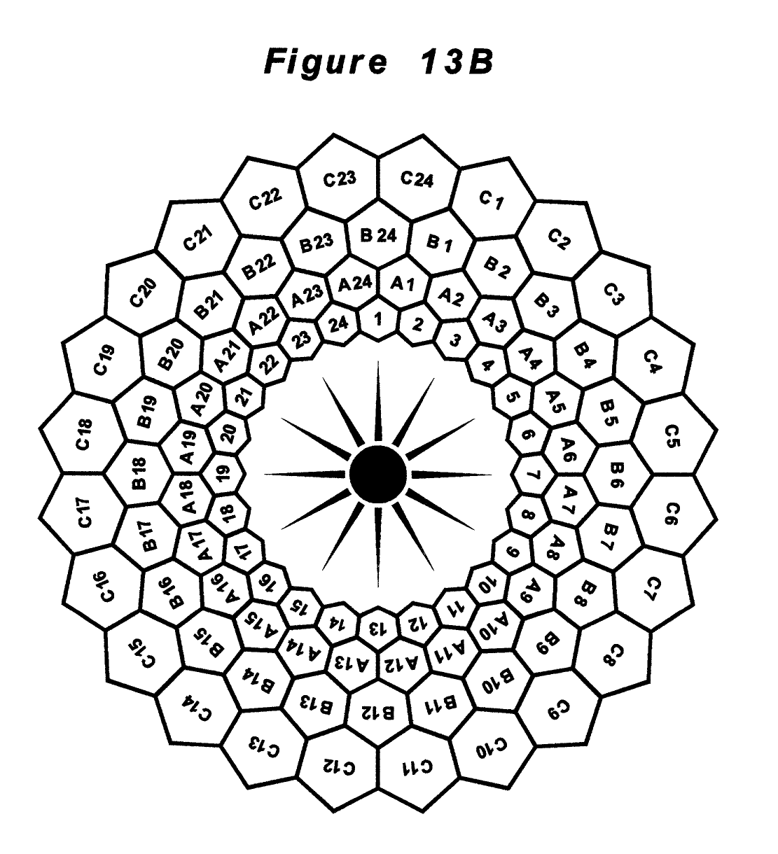

A Starworlds Galactic game begins with the distribution to players of their arrays FIG. 5A, three spacecraft FIG. 4, all of the primary class, spacecraft identity markers FIG. 6A for the three spacecraft, and for each spacecraft identity marker, speed markers FIG. 6B of unit two, and fuel markers FIG. 6C of unit two. In a uni-stellar game each player chooses the distinct heptagon FIG. 2A-#5 upon which they will introduce and exit spacecraft, thereby making it their home station heptagon, or, in a multi-stellar game each player positions their home station marker FIG. 23 upon an initial heptagon—that marker revolving from one heptagon to the next on subsequent moves—that home station heptagon or home station marker being the extension onto the game board of their home station area FIG. 5B-#39 in front of their array, where they will deposit spacecraft and circuit markers until their use. Such deposit converts circuit markers into circuit points, which are exchanged for additional spacecraft. Players position home station markers by, first, arbitrarily numbering the game board heptagons one through six and, second, tossing a six sided die to select which heptagon will receive each player's home station marker. The planet markers FIGS. 7A,7B,7C are positioned initially in each's ring by tossing four cubic die to obtain an integer 4-24 inclusive. For games using the un-enumerated game board FIG. 1 players must select an arbitrary polygon 1 position in each ring from which to begin counting the number of polygons indicated by the die sum for the initial planet marker position. For games using the enumerated game board FIGS. 13A,B the polygon numbers 1-24 are specified. The two outer planet markers are positioned directly opposite one another in ring 7 FIG. 2A-#4, the two middle planet markers are placed directly opposite one another in ring 5 FIG. 2A-#9, and the single inner planet marker is positioned in ring three FIG. 2B-#10. Rings 7, 5, and 3 are also specifically labeled in FIG. 18A. Henceforth, the outer planet markers will be sources of spacecraft fuel.

These actions are taken by players using either the uni-stellar or multi-stellar game board configuration.

I.L Game Play and the Player Goal of Maximizing Fleet Power

Players in their turn then embark their spacecraft from their home station heptagons or home station markers, in uni-stellar or multi-stellar games respectively, each traversing a number of polygons equal to the numeral on each's speed marker; each player advancing on every turn all of their spacecraft in play on the game board. Each player's goal is to increase their spacecraft fleet's potency with respect to the potency of other player fleets by concurrently

(1) accumulating circuit points, exchanged for spacecraft of three varied price and potency classes, and gained by

(a) spacecraft traversal of the central star figure and

(b) pirate registers: registering adversary spacecraft transporting circuit markers and thereby obtaining those circuit markers; and

(2) eliminating adversary spacecraft from the unary, binary, or trinary game board by registering those spacecraft.

I.M The Navigation Component Governing Spacecraft Motion

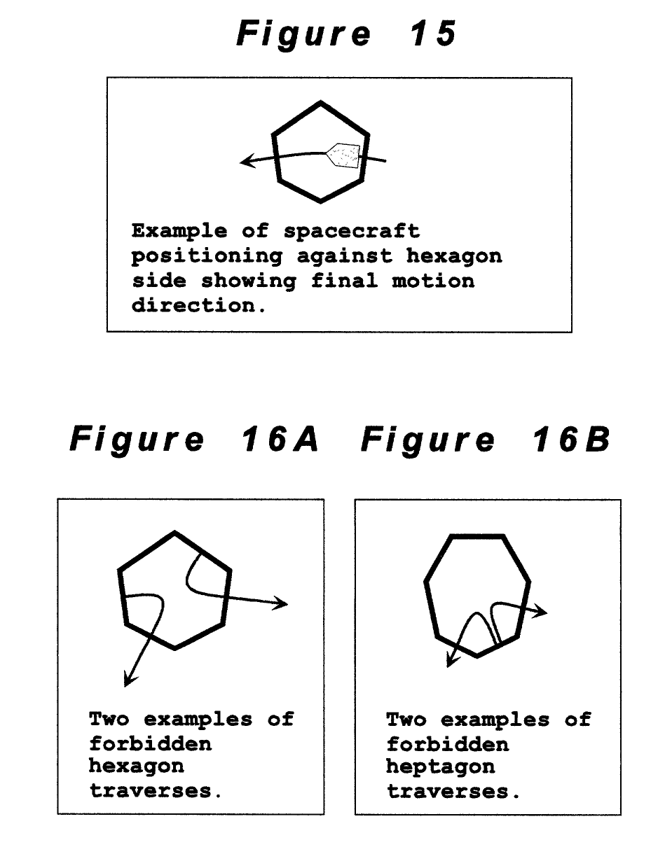

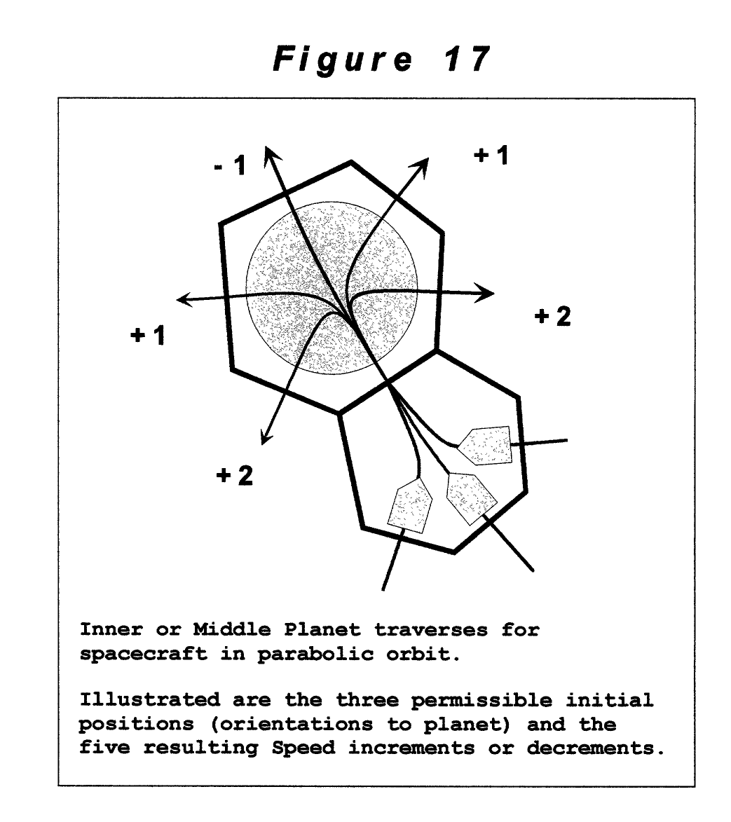

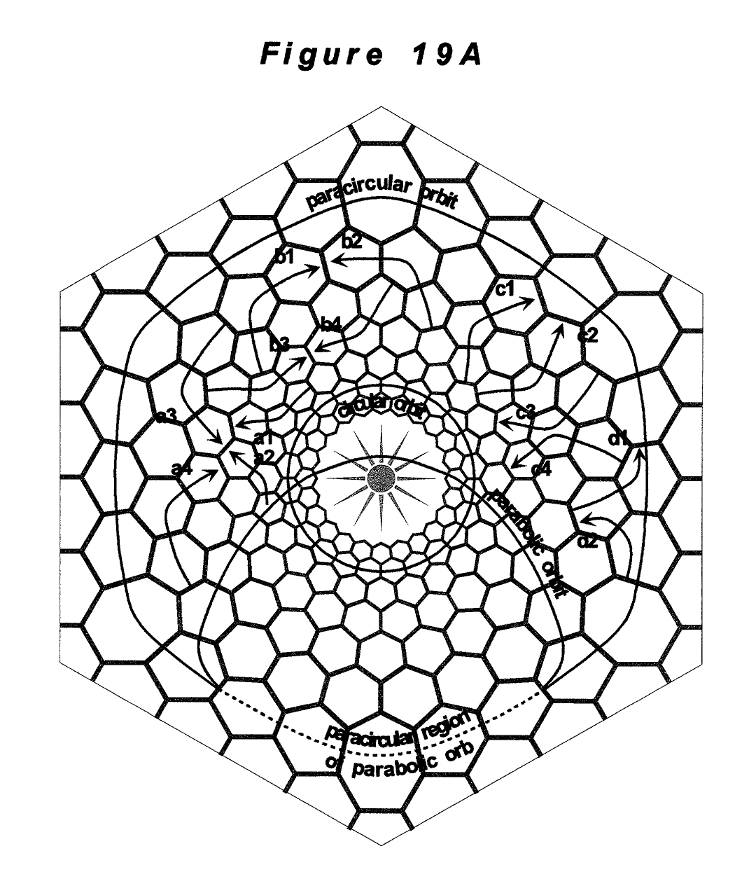

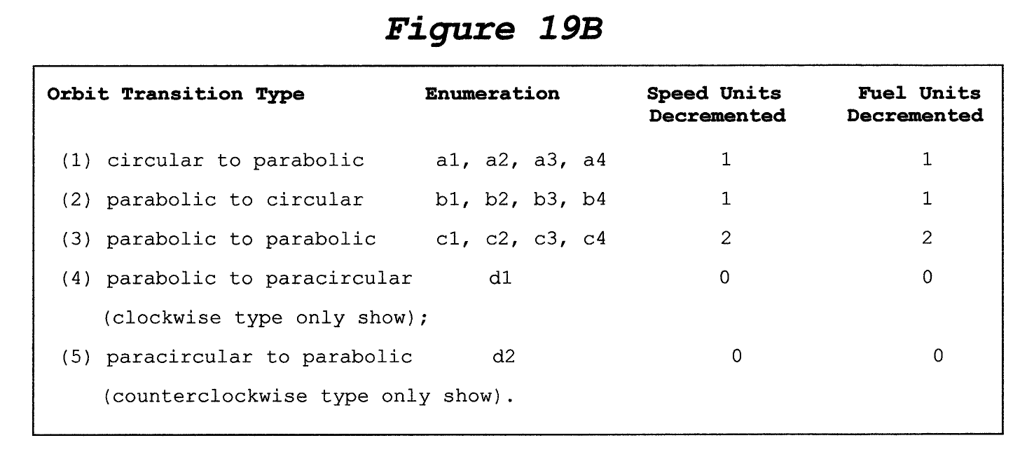

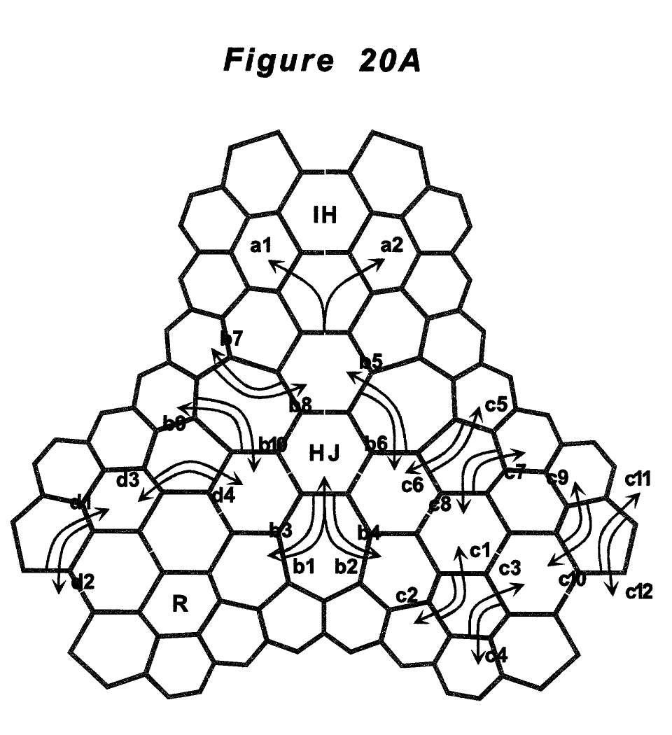

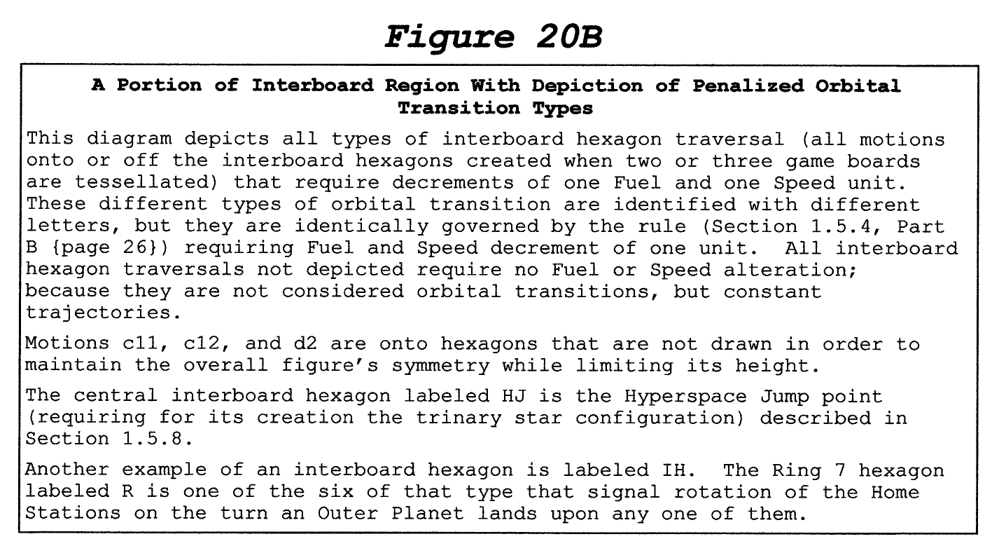

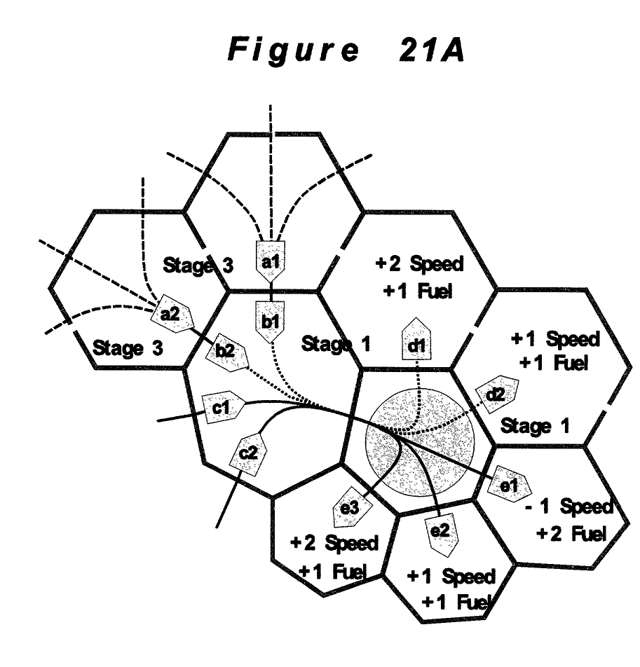

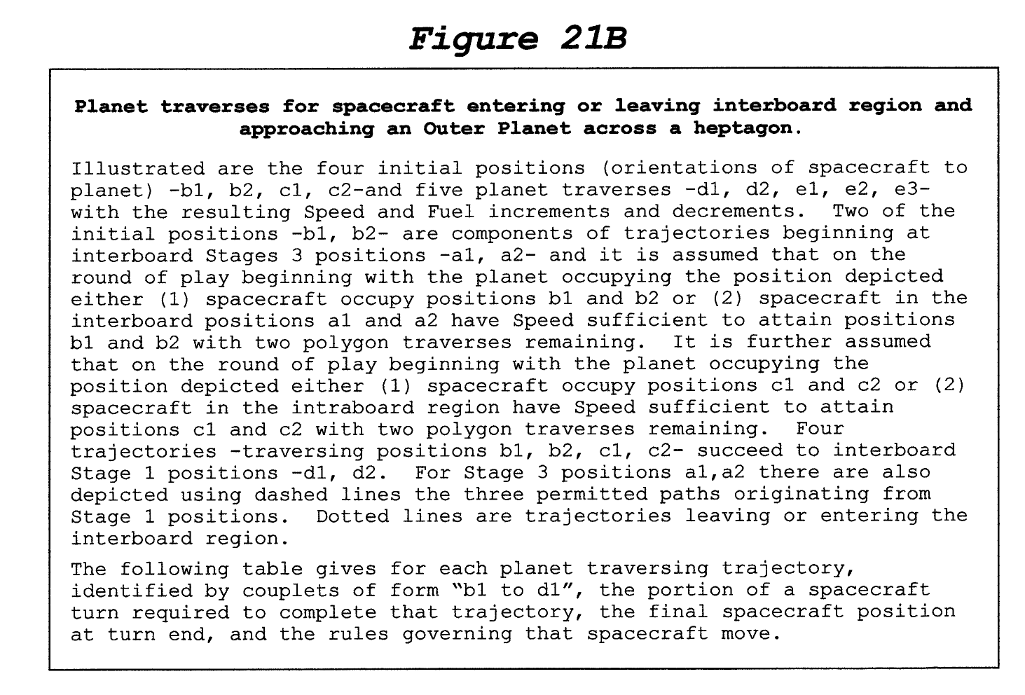

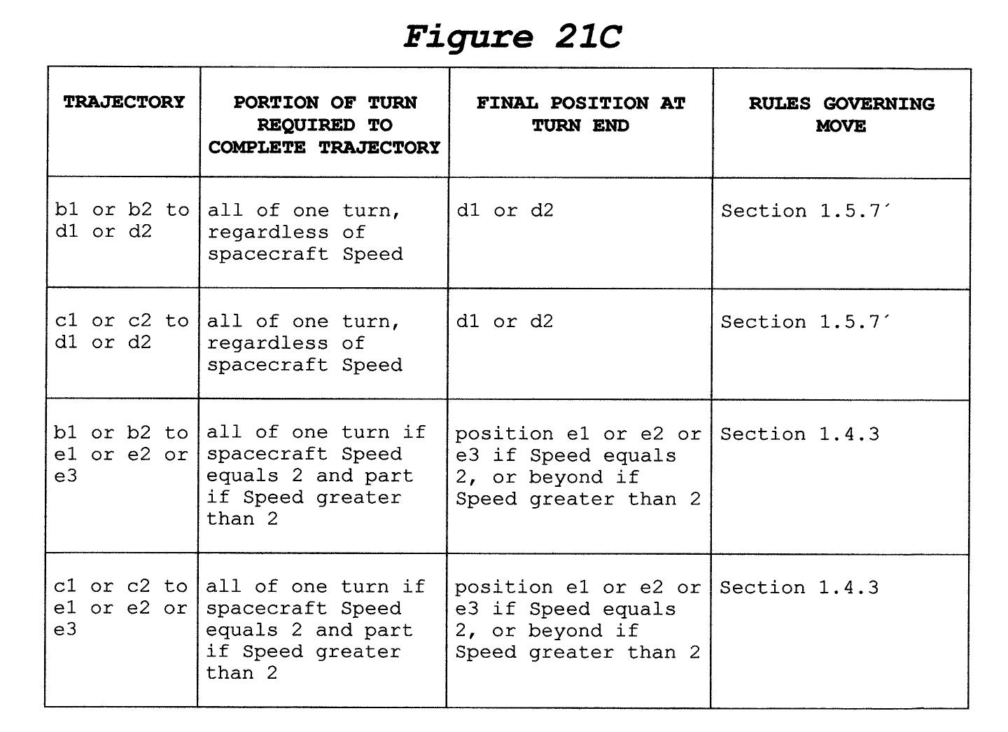

The game rules specify the interaction of a spacecraft's fuel and speed parameters for every possible polygon and planet marker traverse. The game board's tessellation is complex and every such contingency need not be explained, but the essential contingencies involve (a) a correspondence between a spacecraft's speed marker numeral and the number of polygons that spacecraft traverses each player turn, (b) the necessity that a spacecraft always sustains a position with respect to the polygons it traverses or comes to rest upon FIG. 15, (c) traversal of the central star figure, illustrated in FIGS. 18A,B,C in which the star's rays and spaces between rays and ring one polygons are used to delineate specific parabolic orbits, (d) differentiation of circular, parabolic, and paracircular orbits and the fuel decrement required to exit each, illustrated in FIGS. 19A,B, (e) velocity (speed and/or direction) changes resulting from planet marker traversal, illustrated in FIGS. 17 and 21A,B,C, (f) permitted traversals of hexagonal and heptagonal polygons, illustrated in FIGS. 16A,B using forbidden traversals, and (g) speed and fuel implications for velocity changes in the interstellar region, illustrated in FIGS. 20A,B. FIGS. 15-21 are selected from the set of game rules diagrams.

I.N Fleet Power Maximization Dependent Upon Navigation Skill

A player's success at maximizing their spacecraft fleet's potency with respect to other players is determined by their navigational skill: collecting fuel by traversing the outer planet markers and using that fuel to increase or decrease speed or adjust orbit between the circular, parabolic, and paracircular types upon which a spacecraft may advance indefinitely without change of speed or fuel. A specific example of the exchange of fuel for speed in the context of a planet marker encounter is given in the section immediately following.

I.O The Array's Modeling of Spacecraft Parameters

A specific example of the exchange of fuel for speed in the context of a planet marker encounter is the case of a spacecraft in a parabolic orbit that must change to another parabolic orbit, in a maneuver such as that depicted in FIGS. 19A,B cases c1-c4, for the purpose of approaching a middle planet marker in that other parabolic orbit and using a requisite initial position such as depicted in FIG. 17. An additional characteristic of the maneuver is that the spacecraft has fuel 4 and speed 2 and the planet marker is two polygons distant and scheduled to advance at the beginning of the next round of play. Therefore, the spacecraft's speed is first advanced one unit to 3 with a corresponding decrease of its fuel to 3, designating the expenditure of fuel to accelerate the spacecraft and accomplished with corresponding changes of array markers to fuel 3 and speed 3. Now the spacecraft has sufficient speed to traverse the planet marker in one turn, but it still must execute the parabolic to parabolic orbit change depicted in FIGS. 19A,B cases c1-c4. As indicated in those cases, that necessitates the spacecraft's fuel marker being decremented 2 units from the 3 units existing after the speed increase, leaving a fuel 1 marker in the array. Thus, the spacecraft with speed 3 traverses the planet marker to a contiguous polygon, selecting a path designated in FIG. 17 that accelerates the spacecraft one speed unit. Therefore, the maneuver's last requirement is the replacement in the array of a speed 3 marker for a speed 4 marker, which new speed the spacecraft uses on the next player turn. Subsequent the maneuver the spacecraft's array column indicates fuel 1 and speed 4. The player will want to visit an outer planet marker to increase that spacecraft's fuel.

I.P The Distinction Between Players and Teams

Throughout the rules for the uni-stellar game board configuration it is written that a “player” commands a home station and its nine spacecraft. However, to accelerate and simplify the game it is advantageous to distribute control of groups of a player's spacecraft to individuals. Thus, for example, if six of a player's spacecraft are active on a game board, three individuals could control three groups of two spacecraft. When groups of individuals control spacecraft in this way, the “player” becomes a “team” in game rule parlance. In multi-stellar games all players with the same home board may cooperate in their actions as a “team” competing against other home board teams.

I.Q Strategies of Multi-Stellar Games

In multi-stellar games spacecraft can gain circuit markers by traversing non-home board stars, which circuit markers become circuit points available for exchange when the transporting spacecraft returns to its home station, using the device of the home station marker. Game rules may specify that non-home board star traversals can gain multiple circuit markers to encourage wider distribution of adversary spacecraft encounters. Also, hyperspace-jump locations reduce transit-times between game boards.

Multi-stellar games begin with each game board hosting three or four home stations. Each team begins the game competing primarily with teams sharing its home board (although not necessarily, if an advantage to visit another game board exists). Once a team develops a potent fleet on its home board, using registers to reduce adversary fleets and circuit points to enhance its own fleet, it is strategically free to compete on non-home boards until there develops a team dominant on multiple game boards. Thus, beginning with multiple teams on multiple game boards, competition advances across all game boards until there emerges one dominant team.

I.R Synchronization of Team Turns in Multi-Stellar Games

The multi-stellar game requires rules governing the synchronization of team turns that are, first, sequential in the context of one area—intra-board region or inter-board region—and, second, concurrent in the context of multiple areas, with rounds of play in different areas advancing independently according to different tempos (number of rounds of play per time interval). In some games these synchronizations of turns may become sufficiently complex to require pencil and paper to track. An alternative to that synchronization complexity is gained by synchronizing rounds of play on all game boards such that they begin and end with the simultaneous advancement of the planet markers on all game boards. However, that synchronization simplicity's trade-off is that the insurance of uniform play pace across all game boards, such that teams on some game boards do not have to wait for teams on other game boards to complete their play round before the former teams commence a new round of play (after planet marker advancements on all game boards), may require limiting the duration of team turns using a stop-watch or (1, 2, or 3 minute duration) “hour glass”, allotting, for example, two minutes for each team to complete their turn.

I.S Meta-Circular and Meta-Parabolic Orbits in Multi-Stellar Games

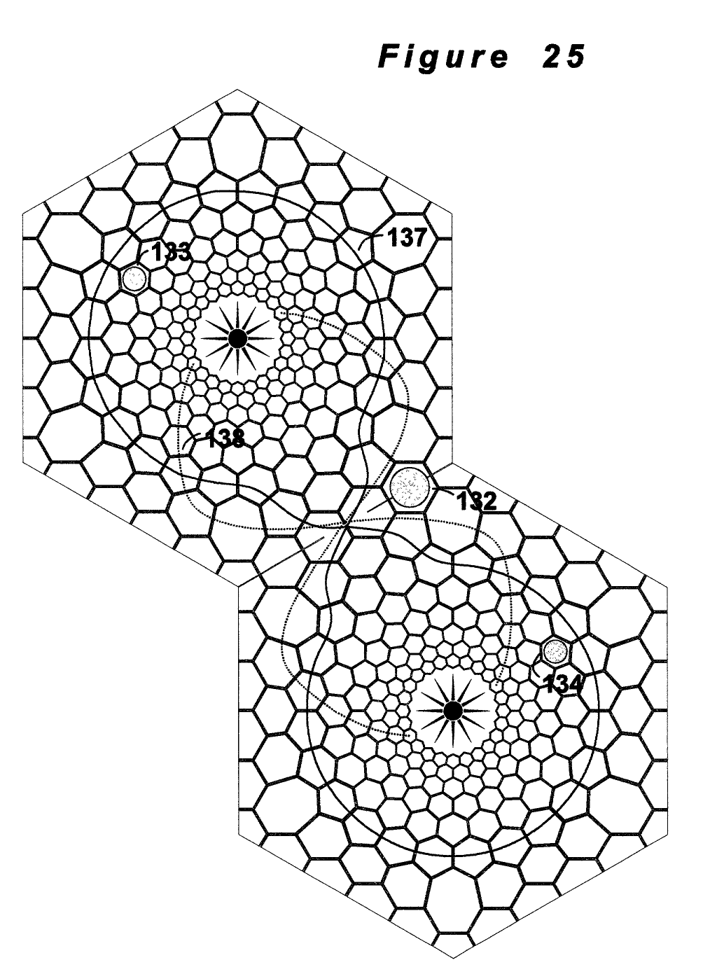

An additional benefit resulting from synchronizing the advancements of all planet markers on all game boards is that it enables plotting complex, stable spacecraft orbits involving planet marker traverses on multiple game boards. There may also be plotted simpler orbits spanning multiple game boards, simulating the influences of the stellar gravities alone. FIG. 24 depicts for the trinary game board configuration a meta-circular orbit 127 and a meta-parabolic orbit 129. Analogous meta-circular FIG. 25-#137 and meta-parabolic FIG. 25-#138 orbits exist for the binary game board configuration.

I.T Consolidation of Multi-Stellar Game Boards to Conserve Frequency of Spacecraft Marker Interaction

In multi-stellar games, boards with less than three active home stations are removed from play and home station and spacecraft markers thereon are moved according to explicit rules to boards with three or more active home stations. This conserves the frequency of spacecraft marker interaction and reduces the number of spacecraft marker moves used entirely to change board position.

I.U Home Stations and Home Station Heptagons in Relation to Uni-Stellar and Multi-Stellar Games

In any game board configuration the home station heptagons remain fixed, being components of the game board tessellation, and in multi-stellar games the location of intra-board hyperspace-jump markers remain fixed, which creates for multi-stellar games respective problems of equal player access from home station heptagons to non-home game boards and intra-board hyperspace-jump markers. The solution is that in multi-stellar games each player has a home station marker FIG. 23 distinguished by color and indicia 109 that rotates around ring 7 FIG. 24-#125 occupying heptagons in the manner of planet markers rotating in ring hexagons. A player's spacecraft access their home station, the area in front of their array, from their home station marker wherever it may be in its rotation, entering and exiting the game board from its location.

I.V Hyperspace-Jump Locations and Markers for Multi-Stellar Games

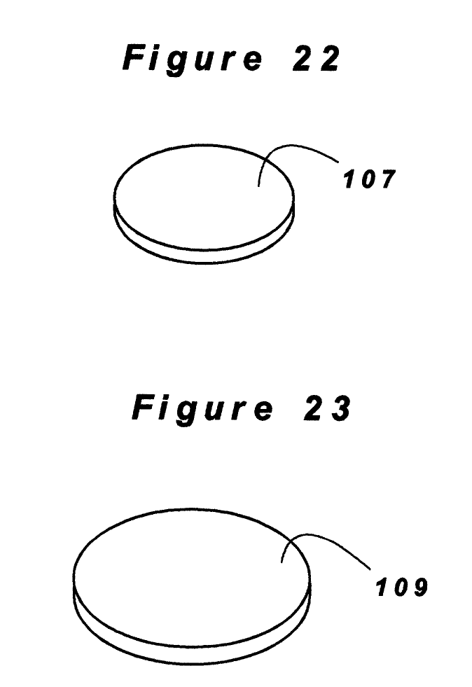

In multi-stellar games using three game boards the centrally located inter-board hyperspace-jump location FIG. 24-#120 is used in conjunction with hyperspace-jump markers FIG. 22, distinguished by color and indicia 107 from other markers, placed upon predetermined intra-board hexagons FIG. 24-#121,#122,#123 such that spacecraft move between any two hyperspace-jump locations using either of two protocols:

(1) Spacecraft move in one step between any two hyperspace-jump locations, accomplishing a hyperspace-jump; or

(2) A player records on paper the number of turns that will transpire before a spacecraft removed from play when it accesses a hyperspace-jump marker will subsequently be re-introduced into play at another hyperspace-jump location, recording additionally that specific location. The paper notation is kept concealed from other players until the turn the spacecraft is re-introduced on the board. These procedures accomplish a hyper-spacetime-jump, simulating an actual spacecraft leaving spacetime at one time and location and reappearing in spacetime at a different location at a future time.

In multi-stellar games using two game boards a hyperspace-jump marker FIG. 22 is placed upon any one of the inter-board regular hexagons FIG. 25-#132—which hyperspace-jump marker takes the place of the aforementioned centrally located inter-board hyperspace-jump location used in trinary game board configurations—and used in conjunction with hyperspace-jump markers placed upon predetermined intra-board hexagons FIG. 25-#133,#134.

I.W Hypertime-Jump Capabilities of Spacecraft Marker Classes

Spacecraft markers can simulate actual spacecraft time travel by either of two protocols:

(1) A player removes a spacecraft marker from the game board and records the subsequent turn upon which they will return that marker to the game board, thereby beginning a hypertime-jump. Using a replica game board, composed of either pencil notation upon paper printed with a game board line drawing FIG. 1 thereon or dry-erase board composed of a board with the game board line drawing printed indelibly thereon and ink that is erasable with respect to the material fabricating the board, the player also records the polygon position and orientation that the spacecraft marker has on the turn that it is removed from play. Hereafter the term present-time game board is used to distinguish what was previously designated game board from the replica game board. The possible number of turns that the player chooses to transpire before returning the spacecraft marker to the present-time game board is constrained by the spacecraft marker's class. When that number of turns has transpired the player then reintroduces the spacecraft marker on the polygon and with the orientation that was documented at the beginning of the hypertime-jump for corroboration by other players. The player keeps concealed from other players the turn number for spacecraft reintroduction that they recorded at the hypertime-jump's beginning. Upon spacecraft marker reintroduction, the player reveals to the other players the recorded reintroduction turn number and decrements the spacecraft marker's fuel. This protocol simulates an actual spacecraft's leaving present spacetime and reentering it at a future time, measured by future planet positions, expending fuel for time-travel energy rather than propulsion;

(2) Using the previously described replica game board a player

(a) chooses a future time measured by planet marker positions advanced in the usual manner,

(b) removes a spacecraft marker from the present-time game board and at that time, using the replica game board, begins a diagram of the spacecraft marker's progression upon the replica game board, commencing from its initial polygon position, which is analogous to its last present-time game board position on the turn it was removed there from, but at the replica game board's future time as measured by the aforementioned advanced planet marker positions. The spacecraft marker's position on the replica game board is advanced one turn for every one turn transpiring on the present-time game board and advanced concurrent with those present-time game board turns. The diagram would include

(b1) encounters with replica planet markers and subsequent adjustments of fuel and speed,

(b2) speed and fuel adjustments because of orbit changes, and

(b3) fuel decrement required for the hypertime-jump.

Circuit marker gain from traversal of the replica game board's central star figure would also be documented. The diagram therefore requires a replica array, consisting of notation on the aforementioned paper or dry-erase board. The diagram is kept concealed from other players until the spacecraft markers' reintroduction, when the diagram is revealed for other players' corroboration. The spacecraft marker is reintroduced on the present-time game board with its analogous final position on the replica game board. The possible number of turns that the player chooses to advance the spacecraft marker on the replica game board before returning it to the present-time game board is constrained by the spacecraft marker's class. This protocol simulates an actual spacecraft's movement into a future time whose universe is created by that hypertime-jump, existing independent of the present-time universe, in order that there is not the logical contradiction of the spacecraft returned to the present-time eventually reaching, in time's ordinary passage, the future time of its past hypertime-jump to encounter itself when in that hypertime-jump it had not encounter itself, in that future time. Also simulated is spacecraft expenditure of fuel for time-travel energy rather than propulsion.

Spacecraft markers of varied classes have varied capacity to hypertime-jump to variedly distant future turns measured by advanced planet marker positions.

I.X The Game Winning Criteria for Uni-Stellar and Multi-Stellar Games

Competition winners are determined by either one of two criteria: elimination of all adversary spacecraft from their uni-stellar or multi-stellar arena or achievement of a pre-agreed number of circuit points, incorporated into spacecraft exchange value and not incorporated (existing as circuit markers), by a pre-agreed upon time, measured by planet marker rotations.

In uni-stellar games, the concurrent processes of fleet development and elimination of adversary spacecraft continues until a player achieves the winning criteria agreed upon at a game's beginning.

In multi-stellar games, teams who achieve dominance upon their home board embark their spacecraft therefrom to compete upon non-home boards, traversing the non-home boards' central star figures to gain circuit markers, used to build and maintain their fleets, and register adversary spacecraft, until there emerges a team dominant upon all game boards, according to the winning criteria agreed upon at a game's beginning.

I.Y The Interactive, Networked Computers Simulation of StarWorlds Galactic

The game described in sections I.A through I.X can be implemented using computer software distributed across a computer network such as, for example, the Internet, and supporting real-time interaction between networked computers with graphical human-to-computer interfaces. Game playing-piece control would include a keyboard and a hand-held pointer device. The essential features of a StarWorlds Galactic computer game would include (allowing “game board” to refer to one or multiple boards):

(1) depiction of a game board on a computer monitor with hand-held pointer device control over game board area viewed and closeness to area viewed (near views displaying smaller areas with larger game markers and distant views displaying larger areas with smaller game markers);

(2) the multiplicity of game boards tessellated, with each game beginning with a minimal number of players with home stations for each board, would be limited only by the computer resources required to support multiple boards each with their multiple players or teams;

(3) the game view on each monitor would have icons used in conjunction with the pointer device allowing a player to display his “array” and “home station” contents, defined above, or the array and home station contents of any selected adversary player;

(4) automatic initialization of home station and planet marker positions at a game's beginning and their advancement at each turn's completion;

(5) automatic update of array information and home station contents when (a) spacecraft markers are advanced on a game board and/or (b) the status of circuit markers changes, including their exchange for spacecraft markers;

(6) movement of spacecraft markers using the pointer device;

(7) display of the probability a spacecraft marker of one class can register an adversary spacecraft marker of the same or different class, and automatic calculation of the success or failure of an attempted register;

(8) hypothetical-scenario views in which game board markers are advanced a chosen number of turns, comprising home station and planet marker advances and also advancement of spacecraft markers—either adversary or belonging to the player controlling the view—with corollary changes of array information displayed. Once the player makes their decisions according to what they have learned with the hypothetical scenario, they return their monitor view to the present-time scenario and move their spacecraft markers accordingly;

(9) automatic advancement of spacecraft markers designated to occupy (a) circular, parabolic, or paracircular orbits described in section I.M above or (b) meta-circular or meta-parabolic orbits such as those described in section I.S above;

(10) automatic removal of under-utilized game boards in multi-stellar games, with spacecraft marker re-assignment to game boards such as described in section I.T above, the removal and re-assignment accomplished according to explicit game rules criteria;

(11) automatic calculation of turn number and fleet values when those are used to determine a game winner according to the method of section I.X above; and

(12) hypertime-jump simulation of spacecraft shifting forward in time with respect to other spacecraft, in which simulation a spacecraft marker can leave the present-time, not time-shifted game board and access a replica, time-shifted game board in which the planet marker positions have been advanced from their present-time game board positions by a number of increments specified by the player. The number of increments represents increasingly advanced future times. The hypertime-jumping spacecraft marker commences its movements on the replica game board from the polygon analogous to that it occupied on the turn it left the present-time game board. On the replica game board, which is a view on the computer monitor separate from the present-time game board view, the spacecraft marker can interact with time-shifted planet markers, resulting in corresponding replica array changes in that spacecraft marker's speed and fuel. If that time-shifted spacecraft marker traverses the replica game board's central star figure, a circuit marker is added to its replica array. The time-shifted spacecraft marker advances one move for each turn that transpires on the present-time game board. The player conceals from other players which replica game board to which they advance their spacecraft marker (i.e., to which time they advance their spacecraft marker, different future times requiring distinct replica game boards), and neither the replica, time-shifted game board nor replica array changes for the time-shifted spacecraft marker are viewable by other players unless such players also have hypertime-jumped spacecraft markers to that same replica game board (i.e., to that same time). The player reintroduces onto the present-time game board their time-shifted spacecraft marker after a chosen number of turns, whose maximum is determined by the spacecraft marker's class, commencing on a polygon analogous to the last it occupied on the replica game board. On the turn the spacecraft marker is reintroduced onto the present-time game board a view documenting its replica game board trajectory and corresponding replica array changes is revealed to other players for their corroboration. Spacecraft markers of varying class have varying capacity to access replica game boards time-shifted (meaning having replica planet marker positions advanced) from the present-time game board by varying increments of turns (i.e., varying capacity to access varying future times). Spacecraft markers occupying the same replica game board can interact in ways identical to their interaction on the initial, present-time game board.

II. UniStar Galactic, the Second Game Embodiment

UniStar Galactic shares with StarWorlds Galactic the simulation of a spacecraft space-race contest, and therefore shares many game markers and rules. However, UniStar Galactic's game board does not tessellate whereas StarWorld Galactic's game board does. Therefore, UniStar Galactic's navigation component uniquely differs from that of StarWorlds Galactic, and thereby the former game is differentiated from the latter.

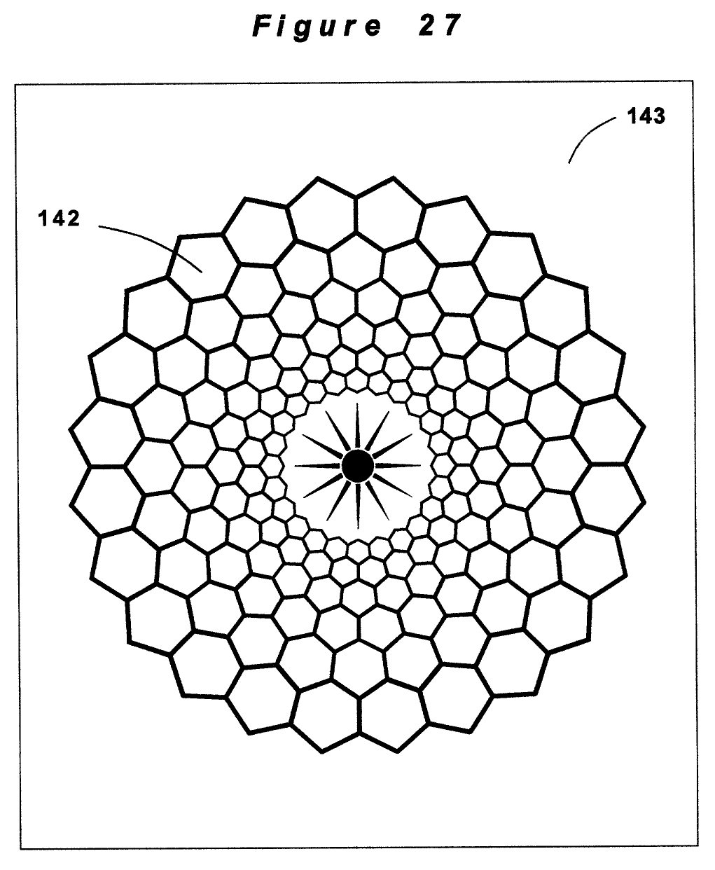

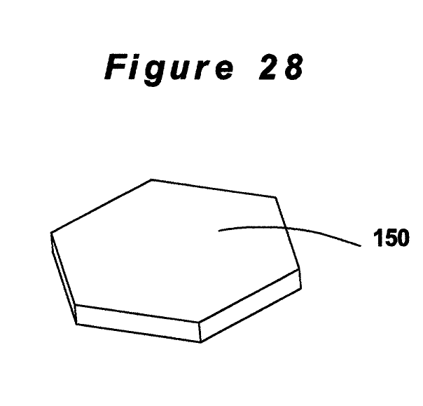

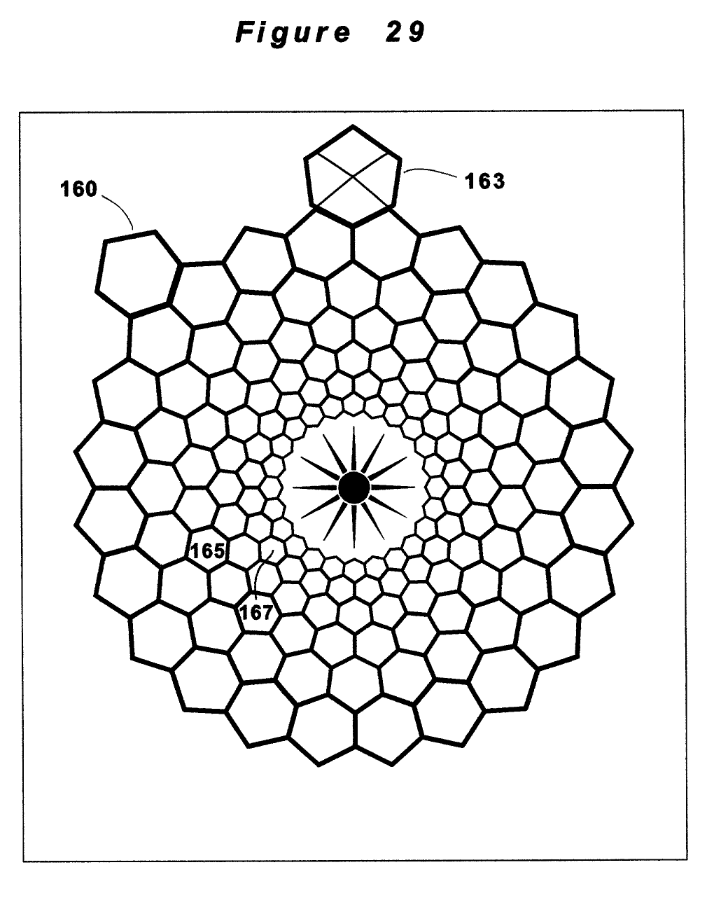

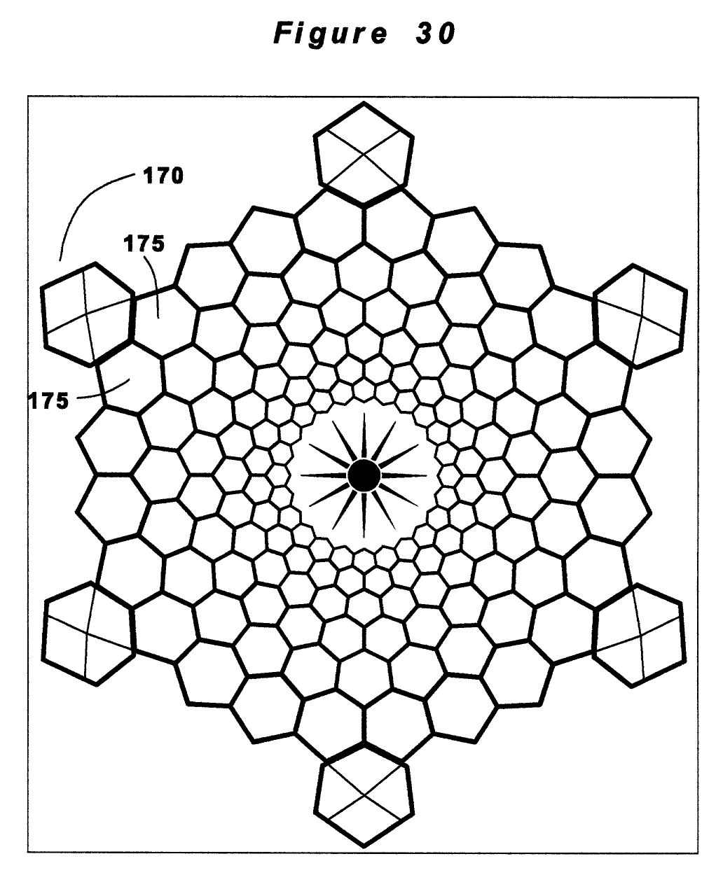

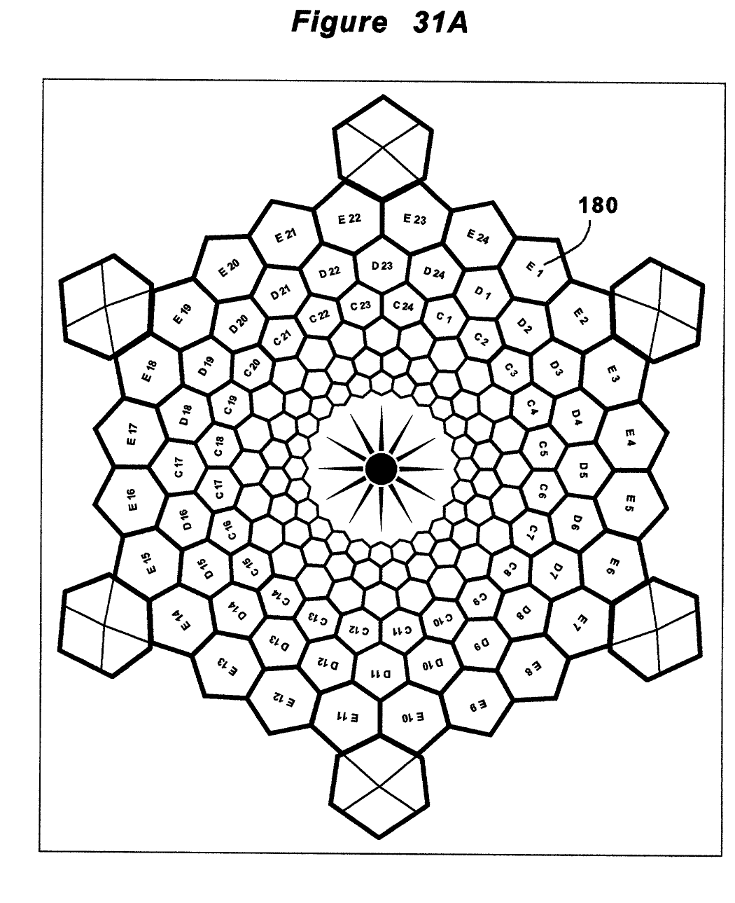

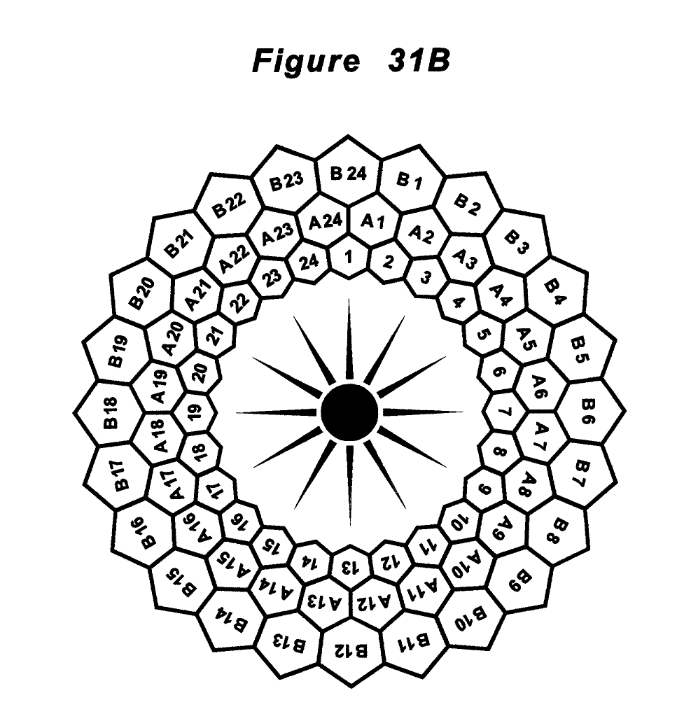

Specifically, UniStar Galactic is the uni-stellar version of StarWorlds Galactic played upon a game board FIG. 27 composed of six concentric rings of contiguous hexagons tessellated within and between rings with a star figure with twelve rays at said concentric rings' common center and non-tessellated space 143 beyond the aforementioned rings for placement of home station markers FIG. 28. Home station markers, distinguished by color and indicia FIG. 28-#150, are shaped to tessellate with hexagon ring 6 FIG. 27-#142 and form fixed platforms FIG. 29-#160 consolidating the functions of StarWorlds Galactic's home station heptagons used in uni-stellar games and home station markers used in multi-stellar games. A maximum of six home station markers may be tessellated in this manner, equiangularly positioned with four ring 6 hexagons separating them. Alternatively, the game board configuration FIG. 30 used for UniStar Synergy can be adapted, wherewith the external planet marker playing pieces FIG. 30-#170 or printed external planet symbols FIG. 30-#170, function as home station markers. Finally, the enumerated game board FIGS. 31A,B with hexagon indicia FIG. 31A-#180 used alternatively by UniStar Synergy can be used, ignoring the enumeration or using it in the manner described in section I.K above to determine the initial planet marker positions.

II.A Initial Playing Piece Distributions and Configurations

The initial playing piece distributions and configurations are identical to those of StarWorlds Galactic with the exceptions

(a) each player is distributed one home station marker FIG. 28, distinguished by color and indicia 150, which is tessellated FIG. 29-#160 with the game board's ring 6. With three players, the home station markers are separated by eight ring 6 hexagons, and with four players, the home station markers are separated by six ring 6 hexagons,

(b) the outer planet markers are placed in the outermost, sixth hexagon ring, and

(c) no hyperspace-jump markers are positioned on the game board.

II.B The Navigation Component Governing Spacecraft Motion

UniStar Galactic's navigation component is identical to that of StarWorlds Galactic described in section I.M with exceptions that include:

(1) The game board's polygonal tessellation consists entirely of hexagons, without heptagons FIG. 2A-#5, and therefore parabolic orbits, analogous to that depicted in FIG. 19A, would not have a “paracircular region” in their closest approach to a game board edge but would instead span tessellated hexagons in the outermost, sixth concentric ring FIG. 27-#142;

(2) The game board has no “inter-board” region FIGS. 20A,B or multiple board configurations FIG. 3;

(3) The outermost planet markers rotate in hexagon ring 6, the ring closest to the game board edge, the middle planet markers rotate in ring 4, and the inner planet marker rotates in ring 2; and

(4) The game does not use hyperspace-jump locations and markers.

II.C The Interactive, Networked Computers Embodiment of UniStar Galactic

The game described in section II can be implemented on interactive, networked computers in the manner described in section I.Y and incorporating specific I.Y paragraphs nos. 1,3,5,6,7,8,11,12. Such computer game would include the additional features

(1) Automatic initialization of planet marker positions at a game's beginning; and

(2) Automatic advancement of spacecraft markers designated to occupy circular and parabolic orbits described in section II.B above.

III. UniStar Synergy, the Third Game Embodiment

UniStar Synergy shares with UniStar Galactic its non-tessellating game board, but the former simulates economic competition subsumed by a moral dynamic whereas the latter simulates spacecraft space-race competition, requiring unique game markers and rules, and thereby the two games are differentiated.

Specifically, UniStar Synergy is played upon a game board FIG. 27 composed of six concentric rings of contiguous hexagons tessellated within and between rings with a star figure with twelve rays at said concentric rings' common center and non-tessellated space 143 beyond the aforementioned rings for placement of external planet markers FIG. 9, which are segmented into four areas 61,62,63,64 for placement of society markers, described below. External planet markers are tessellated FIG. 29-#163 with the game board's sixth, outermost hexagon ring, or positioned proximate therewith, one for each planet marker for a total of six FIG. 30; which latter figure can also represent a game board with six external planet marker symbols printed thereon. An alternative game board FIGS. 31A,B is enumerated with indicia FIG. 31A-#180.

III.A Spacecraft Markers and the Array Mechanism

Spacecraft markers and their speed, fuel, and cargo representations using the array mechanism are identical to that described above in Sections I.B, I.C, and I.D. For brevity, spacecraft markers will henceforth be termed spacecraft.

III.B The Navigation Component Governing Spacecraft Motion

UniStar Synergy's navigation component is identical to that of UniStar Galactic described in section II.B.

III.C The Planet Markers and Their Associated Resource Markers

Planet markers are disks FIGS. 7A,7B,7C with diameters varying according to the size of hexagons composing the ring within which each advances, the markers distinguished by their surfaces' color and indicia 51,52,53. Two outer planet markers advance positioned opposite one another in ring 6 FIG. 27-#142. Two middle planet markers advance positioned opposite one another in ring 4 FIG. 29-#165, and two inner planet markers advance positioned opposite one another in ring 2 FIG. 29-#167. If the enumerated game board is used and events are timed using the method described in section III.X below, then the inner planet markers must be positioned such that they both occupy hexagons enumerated with integers evenly divisible by either two or three. Associated with five of the six planet markers is either a fuel marker or a resource marker. The two outer planet markers are sources of spacecraft fuel. The fuel marker numeral FIG. 6C-#45 indicates a spacecraft's fuel supply. In the future scenario simulated by the game, one middle planet is source of the energy resource required for the engineering development of societies, described below, and therefore one unit of that energy cargo is represented by one energic resource marker FIG. 8A. The second middle planet is source of life sustaining substances such as oxygen and water required for societies' planetary habitations, and therefore one unit of that ecological cargo is represented by one ecologic resource marker FIG. 8B. One of the two inner planet markers is source of mineral resources such as metals and nonmetal elements required for the engineering development of societies, and therefore one unit of that mineral cargo is represented by a mineral resource marker FIG. 8C. All three resource markers are rectangular shaped and scaled to fit on an array ledge, and each is distinguished from the other by color and indicia on a surface 57,58,59.

III.D Spacecraft Marker Capital Value and Purchase Mechanism

Spacecraft markers are available to players in three classes with varying cargo capacity and capacity to deflect catastrophe and entropy events and capacity to extend that protection to nearby spacecraft and societies. The spacecraft are purchased at a rate of two resource markers for one primary class spacecraft, four resource markers for one secondary class spacecraft, and six resource markers for one tertiary class spacecraft, the most powerful. Thus the capital value of spacecraft is their purchase price and a player may exchange their own spacecraft at that rate, for example exchanging two primary class spacecraft for one secondary class spacecraft. Such exchanges occur at a player's home station, the area in front of their array where they deposit resource markers and spacecraft until their use, which home station is accessed when a player's spacecraft lands upon one of the two sixth ring hexagons FIG. 30-#175 that tessellate with or are proximate to the particular external planet marker they have designated to serve as their home station marker.

III.E The External Planet Marker

Associated with each planet marker is an external planet marker FIG. 9, partitioned into four areas 61,62,63,64, one area for each player, and of sufficient size to contain within each player's partition their accumulation of society and population markers, described below, and resource markers. For brevity, planet markers will henceforth be referred to as planets.

III.F Grace Markers

Grace markers FIG. 10 are rectangular shaped, with a numeral 65 to indicate Grace level and adjacent surface 66 with some combination of color and indicia the same for every marker, and scaled to fit on an array ledge. The numeral range is 1 to 12 inclusive. Grace markers are displayed on the right side of an array's first ledge FIG. 5B-#33.

III.G Knowledge Markers

Knowledge markers occur in three categories FIGS. 11A,11B,11C, each marker being rectangular shaped, with a numeral 71,73,75 to indicate knowledge level, and scaled to fit on an array ledge. The three knowledge category markers are distinguished by some combination of color and indicia on the surface 70,72,74 adjacent to said numeral. The first category incorporates knowledge related to physical science, engineering, mathematics, medicine, biology, and agronomy, and may be abbreviated on catastrophe and entropy cards with “C1”, for category one. The second category incorporates knowledge related to social science and management science and may be abbreviated with “C2”. The third category incorporates knowledge related to art, literature, music, history, philosophy, and religion, and may be abbreviated with “C3”. In FIG. 5B knowledge markers of classes c1 37A, C2 37B, and C3 37C respectively are displayed on the right side of the second 31B, third 31C, and fourth 31D array ledges.

III.H Society Markers and Population Markers

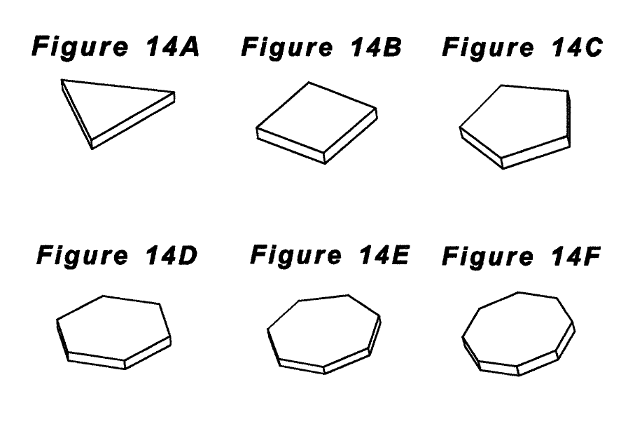

Society markers may be manufactured from sheet material in shapes selected from a group that includes FIGS. 14A,14B,14C,14D,14E,14F. Society markers may be ordered one in relation to the others such that the greater a society's complexity, the greater the number of its marker's sides. For this preferred game embodiment, FIG. 14A is a marker for a base, FIG. 14B is a marker for a colony, and FIG. 14C is a marker for a nation.

Population markers 26A are rectangular shaped and scaled to fit on an array ledge, and each is distinguished from the other by color and indicia on a surface 111.

III.I Society Marker Purchase Mechanism

Society markers are purchased, either directly or indirectly, with some combination of planetary resource markers and population markers. The fundamental unit of society marker is the base, which requires for establishment upon an external planet marker one resource marker from each of the other two planet types, which resource markers are physically transported by spacecraft using the above described array mechanism. One base marker plus one population marker may be exchanged for one colony marker, and two colony markers plus two population markers may be exchanged for one nation marker. Alternatively, population markers may be combined with resource markers to exchange directly for colony and nation markers. Once a society marker is established upon its external planet marker, it causes to be distributed to its player from a central store resource markers of the type associated with its planet and also population markers, thus multiplying those resource markers and population markers for its player and augmenting the player's inventory used to establish further society markers, using their spacecraft via the array mechanism to transport them to their chosen external planet markers. Before a player establishes their first base, however, the player obtains their initial resource markers from planets by traversing those planets, signifying preliminary resource collection expeditions.

III.J Population Markers and the Population Homeostasis Mechanism

Society markers of the colony and nation type require for their establishment, in addition to the proportions of resource markers described immediately above, population markers, representing the labor supply. On turns that base markers generate resource markers they also generate population markers, which are combined with base markers to exchange for colony markers or combined with colony markers to exchange for nation markers. Population markers may also be combined with resource markers to exchange directly for colony and nation markers. Once established, colony and nation markers also generate population markers, which contribute to a player's total capital. Population markers can be distributed between various external planet markers using the array mechanism, simulating spacecrafts' transportation of people. However, population markers differ fundamentally from resource markers in that there is a limit of population markers that can accumulate on an external planet marker before they become not a population resource but a surplus population liability. When that limit is exceeded for any one external planet marker, a player's Grace level is decremented below that displayed on their array for the random process by which a player is required to draw an entropy card. The decremented amount applies only to that entropy card selection random process for that specific turn, and the Grace marker on the player's array is not affected. The decrement amount is determined by a formula incorporating the numbers of surplus population markers for each external planet marker and the number of such latter markers for which such surplus exists. Thus a population homeostasis mechanism is created whereby population growth is required for economic growth, but a surplus population, representing an unemployable population, causes increase in entropic failures, representing social unrest and discord, and thereby decay of that player's economic prospects.

III.K The Composition and Use of Catastrophe and Entropy Cards

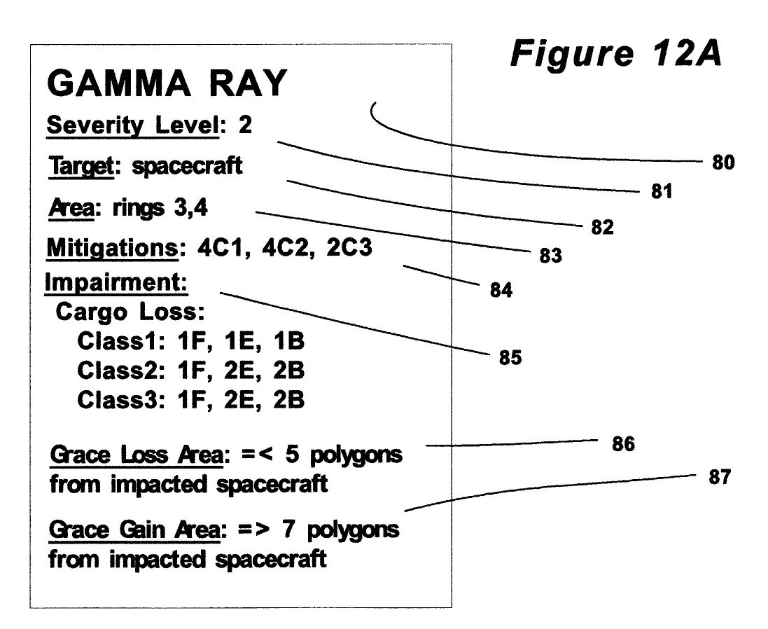

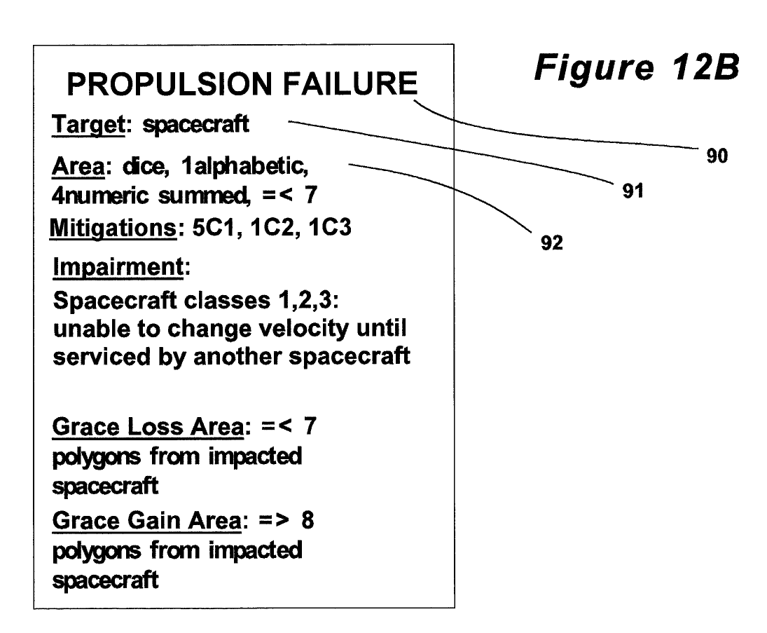

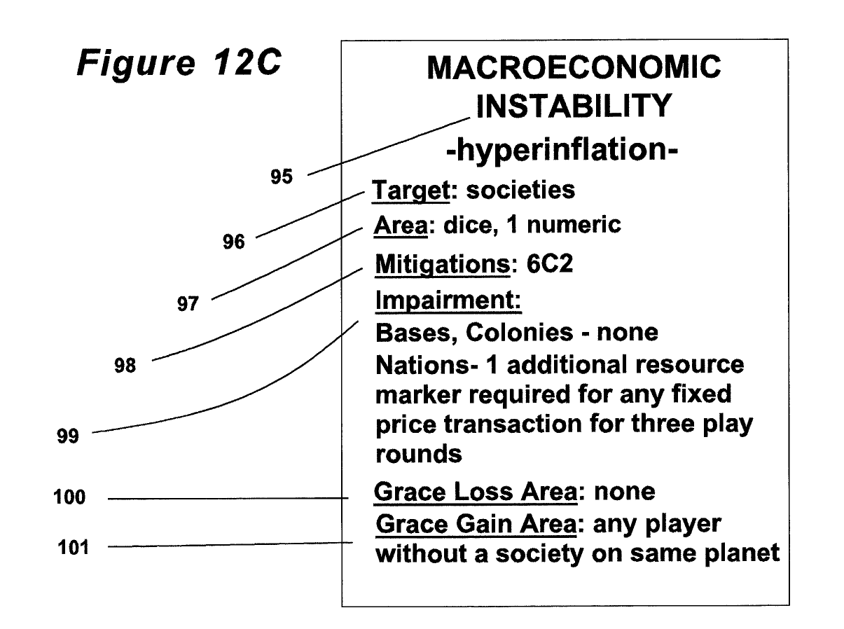

The game is played with two card decks; the cards of one deck providing a source of instruction related to catastrophe: natural phenomena not contingent upon human action and destructive to human purpose; and the cards of the second deck providing a source of instruction related to entropy: the failure of human systems and devices due to causes entirely within such systems and devices and destructive to human purpose. FIG. 12A illustrates one possible catastrophe card, and it provides the player drawing the card information concerning the type of natural catastrophe 80, the catastrophe severity 81, the type of playing piece impaired: spacecraft or society marker 82, a method determining the impact area of that destruction, within which a playing piece is impaired 83, the minimum score for each of said three knowledge categories a player must have for any playing piece in the impact area to avoid being affected 84, the manner of the playing piece's impairment 85, a method determining the area within which the presence of a playing piece of another player necessitates a decision whether to assist the impaired playing piece, wherein a decision to not assist results in Grace level loss and a decision to assist, with diversion of capital, does not change Grace level 86, a method determining the area within which the presence of a playing piece of another player bestows an opportunity to increase the player's Grace level if they chose to assist the aforementioned impaired playing piece, diverting capital to assist, but necessitates no loss of Grace level if that player chooses to not assist 87.

III.L Example of Catastrophe Card Using Gamma Ray Burst

In FIG. 12A the catastrophe is a gamma ray burst of severity 2 which impairs any one of the card drawing player's spacecraft in rings 3 and 4, the player selecting the particular spacecraft if more than one are in that target area. However, if the player has knowledge category C1 points equal to or greater than 4, plus knowledge category C2 points equal or greater than 4, plus knowledge category C3 points equal to or greater than 2 that player averts the impairment. If not, the spacecraft loses resource cargo according to the spacecraft class: class 1 losing 1 fuel unit, 1 energic resource marker, and 1 ecologic resource marker. Losses to other spacecraft classes are interpreted similarly. Players with spacecraft 5 or less polygons distant—wherein each polygon is one distance unit—from the impaired marker on the turn of the catastrophe card's drawing must divert spacecraft to a polygon adjacent to that of the impaired marker or lose 1 Grace level. Players who assist just assist, without resulting Grace level increase. Players with spacecraft 7 or more polygons distant from the impaired marker receive one Grace point if they chose to assist, but are not penalized a Grace level if they chose to not assist.

III.M Example of Entropy Card Used With Enumerated Game Board

The entropy card illustrated in FIG. 12B is used in conjunction with a game set using the alternative enumerated game board FIGS. 31A,B. On that game board some polygons contain indicia consisting of a letter and number FIG. 31A-#180. The letters range from A to E for rings two to six respectively. Within each ring the polygons are numbered 1 to 24. Using that enumeration system, FIG. 12B describes a spacecraft 91 propulsion entropic failure 90 in which the target area 92 is selected by first throwing one six sided die to select a number, the numbers being agreed upon beforehand to match with letters in manner 1-A, 2-B, 3-C, 4-D, 5-E, 6-F. Thus a throw yielding 5 signifies the letter E. Next four cubic die are thrown and the selected numbers summed. For example, the die faces might sum to the number 19. The letter and number thus obtained are combined to signify polygon E19. Reading the remainder of the field, the target area includes polygons 7 or less polygons distant from polygon E19. Other methods might be use to select a particular polygon for this purpose.

III.N Example of Entropy Card Using Hyperinflation

FIG. 12C illustrates another entropy card, designating a hyperinflation entropic failure 95. The target is a collection of player societies 96 on a particular external planet playing piece, which is the target area. That external planet playing piece is selected by the method 97 of throwing one die whose numerals have been agreed upon before hand to match with planets in manner 1,2-M, 3,4-E, and 5,6-B, where M,E, and B signify the mineral, energy, and ecology resource planets, respectively. The societies' impairment 99 is that all player purchases occurring at a fix price, for example one colony for four resource markers, require one extra resource marker. Other player's do not incur Grace lose if they fail to assist the impaired society collection 100. However, any player with no society on that external planet marker can increment their Grace 1 level by assisting the impaired society 101. That assistance's method might be described in a game rules list of general Grace change circumstances as a contribution without remuneration of a sufficient number of knowledge category C2 points so that the impaired society achieves the 6 points needed for impairment mitigation 98.

III.O Stochastic Modeling of Universal Moral Dynamic

Whether a player is required to draw either a catastrophe card or an entropy card is dependent upon chance. A random function device and the frequency (probability) distribution it generates implements that chance. For example, a computer random number algorithm might generate a flat frequency distribution in which there is a 4% chance of selecting each number from 1 to 25 inclusive. The cumulative distribution identifying for each integer—column 3—the probability—column 4—that an integer equal to or greater than that integer will be selected by the random function is demonstrated in Table 2. For each player Grace level, 1-12 inclusive, in column 1 there is a corresponding integer in its row in column 3. If the random function device selects an integer equal to or greater than that integer the player must draw from the catastrophe deck. Thus, there is a correspondence between the integers of column 1 and those of column 3, and this is designated a “type one correspondence”. Similarly, for each player Grace level in column 2 there is a corresponding integer in its row in column 3. If the random function device selects an integer equal to or greater than that integer the player must draw

TABLE 2

| Grace Level | | Integer | Probability Greater Than |
|---|---|---|---|
| Catastrophe | Entropy | Selected | or Equal To Integer |
| | 1 | 1 | 100 |
| 1 | 2 | 2 | 96 |
| | 3 | 3 | 92 |
| 2 | | 4 | 88 |
| | | 5 | 84 |
| 3 | 4 | 6 | 80 |
| | | 7 | 76 |
| 4 | | 8 | 72 |
| | 5 | 9 | 68 |
| 5 | | 10 | 64 |
| | | 11 | 60 |
| 6 | 6 | 12 | 56 |
| | | 13 | 52 |
| 7 | | 14 | 48 |
| | 7 | 15 | 44 |
| 8 | | 16 | 40 |
| | | 17 | 36 |
| 9 | 8 | 18 | 32 |
| | | 19 | 28 |
| 10 | | 20 | 24 |
| | 9 | 21 | 20 |
| 11 | | 22 | 16 |
| | | 23 | 12 |
| 12 | 10 | 24 | 8 |
| | 11-12 | 25 | 4 |

from the entropy deck. The correspondence between the integers of column 2 and those of column 3 is designated a “type two correspondence”. The difference between the type one correspondence and the type two correspondence is that for the former changes of one Grace level result in less change in the cumulative probability in column 4 than for the latter, with the exception of changes for the highest and lowest Grace levels. This simulates a universal moral dynamic in which moral transformation, toward either the good or wicked polarities, has greater corresponding ramification in the realm of human act and artifice than in the realm existing apart from human

TABLE 3

| Grace Level | | Integer | Probability Greater Than |
|---|---|---|---|
| Catastrophe | Entropy | Selected | or Equal To Integer |
| 1 | 1-2 | 1 | 100 |
| 2 | 3 | 2 | 96 |
| | | 3 | 92 |
| 3 | | 4 | 88 |
| | 4 | 5 | 84 |
| 4 | | 6 | 80 |
| | | 7 | 76 |
| 5 | 5 | 8 | 72 |
| | | 9 | 68 |
| 6 | | 10 | 64 |
| | 6 | 11 | 60 |
| 7 | | 12 | 56 |
| | | 13 | 52 |
| 8 | 7 | 14 | 48 |
| | | 15 | 44 |
| 9 | | 16 | 40 |
| | 8 | 17 | 36 |
| 10 | | 18 | 32 |
| | | 19 | 28 |
| 11 | 9 | 20 | 24 |
| | | 21 | 20 |
| 12 | | 22 | 16 |
| | 10 | 23 | 12 |
| | 11 | 24 | 8 |
| | 12 | 25 | 4 |

influence, i.e., the natural realm, which is notorious for visiting disaster upon the benignant and innocent as well as the malefic and morally compromised.

TABLE 4

| Grace Level | | Integer | Probability Greater Than |
|---|---|---|---|
| Catastrophe | Entropy | Selected | or Equal To Integer |
| | | 1 | 100 |
| | 1-2 | 2 | 96 |
| | | 3 | 92 |
| 1 | | 4 | 88 |
| | 3 | 5 | 84 |
| 2 | | 6 | 80 |
| | | 7 | 76 |
| 3 | 4 | 8 | 72 |
| | | 9 | 68 |
| 4 | | 10 | 64 |
| | 5 | 11 | 60 |
| 5 | | 12 | 56 |
| | | 13 | 52 |
| 6 | 6 | 14 | 48 |
| | | 15 | 44 |
| 7 | | 16 | 40 |
| | 7 | 17 | 36 |
| 8 | | 18 | 32 |
| | | 19 | 28 |
| 9 | 8 | 20 | 24 |
| | | 21 | 20 |
| 10 | | 22 | 16 |
| | 9 | 23 | 12 |
| 11 | | 24 | 8 |
| 12 | 10-12 | 25 | 4 |

III.P Variation of Universal Moral Dynamic Clemency-Punitiveness

Table 3 illustrates, for the same cumulative distribution used in Table 2, type one and two correspondences in which Grace levels have been shifted toward higher cumulative probabilities, whereby is simulated a universal moral dynamic more punitive than that signified in Table 2. Alternatively, Table 4 illustrates for Table 2's cumulative distribution, type one and two correspondences in which Grace levels have been shifted toward lower cumulative probabilities, whereby is simulated a universal moral dynamic more forgiving than that signified in Table 2. Thus, Table 2 signifies a moral dynamic intermediate between Table 3 and Table 4 in its clement-punitive degree. Before commencing a game, players chose which moral dynamic clement-punitive degree to structure their interaction.

For subsequent discussion of the preferred game embodiment, the random function device will be four tossed cubic die whose faces are summed to obtain an integer occurring in a cumulative distribution analogous but not equivalent to that in the Tables.

III.Q The Criteria for Winning in UniStar Synergy

Starworlds Synergy progresses according to a complex dynamic. A game winner is determined by first summing each player's three knowledge category levels to obtain a collective knowledge level for each player, and then multiplying each player's collective knowledge level times their Grace level to obtain their duplex score; the player with the highest duplex score being the game winner. In games using multiple game boards in a multi-stellar game board configuration players on all game boards may compete individually against each other or each game board's collection of players with home stations thereon may be deemed teams working in cooperation and their team scores being the duplex score derived by multiplying the average of team member's collective knowledge levels times the average of their Grace levels. In either uni-stellar or multi-stellar games a criterion must be selected for cessation of play and comparison of competitor (player or team) scores, since the absence of competitor method or incentive to eliminate each other's playing pieces can cause protracted games. One criteria is to use an outer planet, which revolves slowest of the planet types, like the hand of a clock and cease play when the planet achieves a predetermined position. Another criteria is to cease play when one competitor (player or team) achieves a pre-stated number of societies, such as, for example, nations on three planets.

III.R Duplex Score Maximization

Maximization of the duplex score, therefore, requires maximization of both the knowledge and Grace levels, which is a player's or team's primary objective. Society markers established on external planet markers—which are motionless representations of planets revolving on the game board—cause to be distributed to players the three knowledge category points. Society markers occur in three degrees of complexity,—bases, colonies, and nations—and each generates a different mix of the three knowledge category points. A player's collective knowledge level is the sum of their three knowledge category levels, which set of three numbers is termed the player's knowledge triple. Society markers generate those three categories of knowledge points at regular intervals determined by the position of planets in their orbits. Since each individual society marker established for a player generates knowledge points, a subsuming player strategy is to maximize the number of their society markers.

III.S Spacecraft Navigation Skill Required to Develop Societies

Since the establishment of society markers and the purchase of differentially powerful spacecraft depend upon a player's use of spacecraft to transport, using the array mechanism, resource and population markers between varying embarkations and destinations of planets and home stations, using the external planet marker device for each, skillful navigation through the stellar planetary field, represented by game board paths, is crucial. Each spacecraft carries a fuel supply, which can be incremented by traversing an outer planet, simulating an orbit used to gather energetic subatomic particles trapped in the planet's magnetic field. That fuel can henceforth be exchanged for some combination of spacecraft speed change and direction change, in which maneuvers the speed marker's numeral is changed and/or the spacecraft's direction is changed coordinate with decrements of the fuel marker numeral. The skillful player utilizes circular and parabolic orbits, which a spacecraft can maintain indefinitely without changes to its speed or fuel. Exit from such stable orbits, however, usually requires fuel decrement. All planets can be used to change spacecraft direction without fuel use and with resulting speed increase. The star figure's twelve rays and the twelve spaces between rays are used to guide spacecraft traces of parabolic orbits near the star figure.

III.T Determinants of Grace Level

As completely as is practically feasible, all player decision's with direct ramification for other players are subsumed in their consequence for the deciding players by a moral dynamic. Sometimes that consequence, in terms of Grace level change, is dictated by a general list covering circumstances such as player bartering and deal making, but most often the player decision is forced by the mechanism of the above described catastrophe and entropy cards. At the beginning of each turn a player selects an integer using a random function device, which in this game embodiment is the sum of the faces of four tossed cubic die, and then using a table such as described above compares that integer to an integer dictated by the player's Grace level to determine whether the randomly selected integer is equal to or greater than the player's Grace level dictated integer. If that is the case the player must draw a catastrophe card. Then the player repeats the random function procedure to obtain a second integer, which the player compares to another integer, in a second table column, also dictated by the player's Grace level to determine whether to draw an entropy card. The player drawing a card of either type risks the loss or restriction of a society marker or spacecraft, and other player's may or may not, according to conditions dictated upon the card, be forced to decide between sacrificing Grace level, incurring Grace level decrement for the immediate goals of a playing piece, or sacrificing the immediate goals of a playing piece for Grace level increment. Since the crucial integers dictating whether a player risks loss subsequent a catastrophe or entropy card draw are dependent upon a player's Grace level, that Grace level partially determines the frequency that a player risks loss (the other determining part being random selection structured by a frequency distribution). Thereby is simulated a universal moral dynamic subsuming player decisions regarding other players. As explained above, that moral dynamic can be adjusted in its clement-punitive degree, the frequency at which player's risk loss, by the players, selection at a game's beginning of a correspondence shifted toward higher or lower cumulative probabilities.

III.U Synopsis of UniStar Synergy Play

Thus, in this exchange and maneuver of markers is simulated parties in a distant human future, economically engaged in a stellar planetary system, owning fleets of spacecraft which are used to initially extract and transport planetary resources to establish societies of varying complexity in order that those societies can contribute to those players' wealth by

(a) further development of planetary resources, distributed by spacecraft, to further establish societies and procure additional spacecraft of varying capability,

(b) development of populations providing labor resources, which are subsequently required for additional and more complex societies and are distributed between those societies by spacecraft transportation, but which populations must grow proportionate to their need and cause social upheaval when the labor they provide exceeds its demand, and

(c) development of players' knowledge stores.

Spacecraft navigation is fundamental to those parties' prospects of wealth accumulation because they are the sole means of resource distribution, and skillful navigators master orbits which collect fuel from planets distant from their star and adjust orbit and speed while conserving fuel by encounters with planets. Spacecraft and societies both are threatened by an abundance of catastrophic natural phenomena and entropic failure of human created systems and devices, and the knowledge produced by societies enable those parties to avoid or recover from such hazard which occur randomly in part as a function of each party's accumulated morality achieved through their history of neglect or response to the tribulations of other parties. It is knowledge multiplied by Grace that establishes the supreme competitor.

III.V Initial Playing Pieces Distributions and Configurations

The initial playing pieces distributions and configurations are identical to those of Starworlds Galactic, with the exceptions that

(a) each player is distributed one level 7 Grace marker FIG. 10 (intermediate in range 1-12), placed on the right end of that player's array's topmost ledge FIG. 5B-#33,

(b) six external planet markers are positioned around the game board's sixth, outermost ring with four ring hexagons separating each external planet marker from its neighbors FIG. 30,

(c) each player chooses one external planet marker as the place for entering and exiting spacecraft from the game board, the selections made so that the external planet markers are separated by 8,6, and 4 ring hexagons for games with 3,4,and 6 players respectively,

(d) the outer planet markers are placed in the outermost, sixth hexagon ring, and

(e) no hyperspace-jump markers are positioned on the game board.

Henceforth, the outer planets will be source of spacecraft fuel, the middle planets will be source of ecologic and energic resource markers respectively, and one of the two inner planets will be source of mineral resource markers.

III.W The Grace Process

Beginning with the second round of player turns, each player as the first act of their turn selects an integer which is the sum of the faces of four tossed die and uses a table such as Table 2 to determine whether to draw from the catastrophe card deck. Then using card instructions FIG. 12A-#80,#81,#82,#83,#84 the player determines whether a playing piece has been impaired, and if so commences the impairment condition FIG. 12A-#85. All other players then use the card's instructions FIG. 12A-#86,#87 to determine whether a Grace decision is incumbent upon them. Then this sequence of acts and decisions is repeated with regard to the entropy deck. On the subsequent turns of each player for whom a Grace decision was incumbent, that player commences the movement or exchange of playing pieces which implements their decision. When a player makes a decision causing a Grace level increase, their Grace marker in their array is replaced with a marker with an incremented integer. Alternatively, when a player makes a decision causing a Grace level decrease, their Grace marker is replaced with a marker with a decremented integer.

III.X Planet Rotation Synchronization and Its Governance of Population, Resource, and Knowledge Distributions from Societies

The methods of synchronizing planet advances upon either un-enumerated or enumerated game boards simulate planets whose orbital periods vary according to their distance from their star. Using the un-enumerated game board, beginning each round of play subsequent the first, the planets are advanced in their orbit according to the schedule: (1) the two inner planets advance one polygon on each turn, (2) the two middle planets advance one polygon every other turn, and (3) the two outer planets advance one polygon every third turn. A player must be designated to note with pencil and paper the passage of second and third turns. On every third turn the presence of society markers on external planet markers causes to be distributed to their players from a central store resource markers, population markers, and knowledge points in the three knowledge categories; the increments achieved for the latter by replacing in their array positions knowledge markers for markers with higher numerals. This pattern of planet advances and resource, population, and knowledge distributions is maintained in games using the enumerated game board, except that the middle planets are advanced every time the two inner planets (opposite one another) land upon polygons labeled with an integer divisible without remainder by two, and the outer planets are advanced every time the two inner planets land upon polygons labeled with an integer divisible without remainder by three.

III.Y The Varieties of Player Capital and the Exchange of One Form for Another

Each player's collection of spacecraft, society markers, resource markers, population markers, and knowledge points constitutes their capital, and players are free to exchange that capital according to their interests. For example, a player may exchange some number of resource markers accumulated upon an external planet marker for the use of another player's spacecraft to transport some number of additional resource markers to another external planet marker, where the hiring player might need those resource markers to establish a society marker. Another example would be a player who has drawn an entropy card whose instructions threaten a society marker and which player lacks the knowledge points designated on the entropy card to avoid the impairment. That player might negotiate with another player, exchanging resource markers for the latter player's knowledge points to achieve the knowledge triple required by the entropy card to avoid the impairment. The purchasing player's knowledge marker levels are accordingly incremented, but the selling player's knowledge marker levels are not changed because knowledge is not lost when it is distributed. The Grace ramifications for such deals are explicated in a list of general conditions included in the game rules. If the selling player had instead donated the knowledge without remuneration that player would benefit an increment of their Grace level.

III.Z The Cyclical Collective Contribution of a Player's Society Markers to Their Three Knowledge Categories

Each society marker a player has established upon an external planet marker generates some mix of the three knowledge category points at regular intervals of play rounds. At that time the three categories of knowledge points generated by all of a player's society markers are summed according to category and those sums for each category are used to increment the corresponding knowledge marker levels, one for each category 37A,37B,37C (the player's knowledge triple), in the player's array.

III.AA The Interactive, Networked Computers Embodiment of UniStar Synergy

The game described in section III can be implemented on interactive, networked computers in the manner described in section I.Y and incorporating specific I.Y paragraphs nos. 1,3,6. Such computer game would include the additional features:

(1) automatic initialization of planet marker positions at a game's beginning and their advancement at each turn's completion;

(2) automatic advancement of spacecraft markers designated to occupy circular and parabolic orbits described in section II.B above;

(3) automatic update of array information and home station contents when spacecraft markers are advanced on a game board;

(4) automation of the Grace process, including

(a) the process incorporating a player's Grace level and a random function which determines at each turn's beginning whether a player is catastrophe and/or entropy sanctioned, specified in sections III.O,P;

(b) graphical analogues of the catastrophe and entropy cards with those cards' information, specified in section III.K;

(c) game board Grace gain and Grace loss areas—specified in section III.K—highlighted on the monitor by some combination of changed light intensity and color;

(d) display of the success or failure of a player's C1, C2, and C3 knowledge levels to mitigate catastrophe and/or entropy sanction, specified in section III.K and exemplified in sections III.L,M,N;

(e) recording of each player's choice to assist or not assist a catastrophe and/or entropy sanctioned player's impaired game markers and determination of such former player's actual fulfillment of that assistance, specified in section III.K and exemplified in sections III.L,M,N;

(f) impairment of a player's game markers or successful nullification of that impairment by another player accounted for on subsequent turns, specified in section III.K and exemplified in sections III.L,M,N;

(g) hypothetical scenario generation enabling a player to display future turn planet marker positions, advance according to that player's discretion other game marker's, and choose specific catastrophe and entropy scenarios with their corresponding Grace gain and loss screen highlights, without affecting the actual game board scenario, to which the player returns after making decisions according to that hypothetical scenario;

(5) automation of other fundamental game processes, including

(a) the knowledge marker mechanisms, specified in sections III.G,X,Z;

(b) the society marker mechanisms, specified in sections III.H,I,X,Z;

(c) the resource marker mechanisms, specified in sections III.C,X;

(d) the external planet marker mechanisms, specified in sections III.E,I,J,X; and

(6) automatic tabular display of player capital, specified in section III.Y;

(7) population homeostasis, including projected growth and corresponding projected influence on Grace level used in entropy prompt sanction, specified in section III.J; and

(8) automatic calculation and display of player duplex score, specified in sections III.Q,R;

(9) Hypothetical-scenario views in which game board markers are advanced a chosen number of turns, comprising planet marker advances and also advancement of spacecraft markers—either competitor or belonging to the player controlling the view—with corollary changes of array information displayed. Once the player makes their decisions according to what they have learned with the hypothetical scenario, they return their monitor view to the present-time scenario and move their spacecraft markers accordingly.

III.AB The Game Winner

When the condition of play cessation agreed upon at a game's beginning occurs, the players' duplex scores (in uni-stellar games) or teams' duplex scores (in multi-stellar games) are calculated and the game winner declared.

What is claimed is:

1. A game apparatus for use by a plurality of players that simulates sports-like competition between spacecraft navigating intra-stellar and interstellar planetary gravitational fields, and comprising:
a planar game board means having the shape of a regular hexagon whose center is the common center of a plurality of concentric rings of contiguous hexagons tessellated within and between rings, enabling the outermost ring to tessellate with linearly contiguous polygons tessellating said game board means' six sides, which boundary polygons conjoin with the boundary polygons of a second, congruent and identically tessellated, adjacently placed said game board means, aligning vertex to vertex any side of one game board means to any side of the other, to form a row of regular hexagons along the shared edge; thereby enabling a plurality of said means of game boards to be tessellated in a manner extending without interruption the internal, concentric polygonal paths of one into the identical internal, concentric polygonal paths of another,
whereby the interrelation of adjacent stellar gravitational fields, universally spherical in structure, is cross-sectionally simulated;
a plurality of planet markers, each said planet marker advancing within one of said concentric rings according to predetermined pattern and synchronization;
a plurality of spacecraft markers, each said spacecraft marker being distinguished according to player,
each said player's collection of spacecraft markers being distinguished according to class,
the player's spacecraft markers of particular said class being individually distinguished;
a plurality of circuit markers, one said circuit marker representing one traversal of said game board central star figure by one said spacecraft marker;
a plurality of home station markers, providing locations where said spacecraft markers are entered upon and removed from said game board means;
a plurality of player parameter display means, one for each player, each said parameter display means comprising:
(a) spacecraft identity markers, each of which identifies one said spacecraft marker in play on the game board means, and
(b) for each said identity marker additional said display elements comprising speed markers and fuel markers,
whereby the speed and fuel of each spacecraft marker in play is disclosed for all players to know,
(c) for each said identity marker a plurality of said circuit markers, including one and none;
a navigation means, including player discretion, governing the interaction between said spacecraft markers, said central star figure, said contiguous paths of polygons, and said planet markers,
wherein a spacecraft marker trajectory, consisting of position and orientation upon the game board means, spacecraft marker speed, and spacecraft marker fuel, is altered with predetermined pattern and, according to other predetermined patterns, not altered;
a registering of one said spacecraft marker by another spacecraft marker in which the registering spacecraft marker causes the registered spacecraft marker's removal from the game board means,
whereby one spacecraft's laser-strike against the hull photo-receptor target of another is simulated;
a means for determining said registering comprising a frequency distribution over a set of numbers and a random function device generating said distribution;
said game board means used tessellated with a plurality of additional congruent and identically tessellated means of game boards and said game board means used singly, without tessellation with additional means of game boards;
whereby respectively is simulated multiple and single star planetary systems;
said plurality of tessellated means of game boards configuration having rules comprising:
(a) synchronization of player turns that are sequential in the context of player turns on said single game board means and concurrent in the context of said sequenced player turns on one game board means progressing independent of sequenced player turns on another game board means, and
(b) an alternative synchronization of player turns upon all means of game boards coordinated by the concurrent advancement of planet markers on all means of game boards,
whereby is enabled the plotting of complex spacecraft marker trajectories involving traverses of planet markers on multiple means of game boards,
whereby is simulated spacecraft trajectories in multi-stellar planetary systems;
a criteria for determining a game winner comprising the winner either
(a) eliminating opponent said spacecraft markers from said game board means comprising said single game board means or said multiple tessellated means of game boards,
or
(b) the winner accumulating the most valuable set of spacecraft markers, measured in said circuit marker exchange units, after a number of player turns agreed upon at a game's beginning.

2. A game as in claim 1 wherein the criteria for determining a game winner comprises:
(A) in uni-stellar games: the player who eliminates said spacecraft markers of all other players from said game board means,
(B) in multi-stellar games: the player who eliminates the spacecraft markers of all other players from said multiple means of game boards,
(C) in multi-stellar games in which all players having the same home board cooperate in their actions as a team competing against other said teams: the team who eliminates the spacecraft markers of all other teams from the multiple means of game boards,
(D) in uni-stellar games: the player who achieves the most valuable fleet, measured by the number of circuit points required to exchange for that fleet, by a pre-agreed round of play determined by said planet marker positions,
(E) in multi-stellar games: the player who achieves the most valuable fleet, measured by the number of circuit points required to exchange for that fleet, by a pre-agreed round of play determined by planet marker positions on one pre-agreed game board means,
(F) in multi-stellar games in which all players having the same home board cooperate in their actions as a team competing against other said teams: the team who achieves the most valuable fleet, measured by the number of circuit points required to exchange for that fleet, by a pre-agreed round of play determined by planet marker positions on one pre-agreed game board means.

3. A game as in claim 1 comprising additionally a hypertime-jump means
wherein a player can advance a said spacecraft marker from its polygon position on said game board means onto the analogous polygon position on a replica means of the game board means, on which said replica means the said planet markers have been advanced an incremented number of positions with respect to those positions on the former, initial game board means, thereby defining the former game board means as present-time and said replica game board means as future time-shifted,
wherein the spacecraft marker advanced to the replica game board means can return to said present-time game board means,
wherein on the replica game board means the spacecraft marker advances according to the same said navigation means component that governs its motion on the present-time game board means,
wherein a replica said parameter display means is formed for that specific spacecraft marker with replica said speed and fuel notation, thereby defining the parameter display means corresponding to the present-time game board means as the present-time parameter display means,
wherein the spacecraft marker can interact with replica planet markers with corresponding said replica parameter display means changes to its replica speed and fuel,
wherein the spacecraft marker can traverse the replica game board means' said central star figure and gain a replica said circuit marker for its replica parameter display means which said replica circuit marker is transferred to the present-time parameter display means when the spacecraft marker returns to the present-time game board means,
wherein said spacecraft marker classes are differentiated according to capability to access replica means of game boards time-shifted into varyingly distant future times represented by advancements of the positions of the replica planet markers,
whereby spacecraft travel to varied future times and return to the present times of their embarkation is simulated.

4. A game as in claim 3
wherein said hypertime-jumping spacecraft marker returns to said present-time game board means on the polygon corresponding to the last polygon it occupied on said replica game board means,
wherein other players have knowledge neither of the spacecraft marker's trajectory on the replica game board means nor of its said replica parameter display means,
wherein on the turn the spacecraft marker returns to the present-time game board means said knowledge of its trajectory and replica parameter display means is revealed to other players.

5. A game as in claim 4 wherein said hypertime-jump means comprises a line drawing replicating in concise manner said present-time game board means and an instrument to notate on that replica game board means said spacecraft marker moves and said planet marker advances,
wherein said line drawing and said instrument to mark thereon comprises lines printed on paper and pencil or comprises a board with the replica line drawing indelibly printed thereon and ink that is erasable with respect to the material fabricating said board.

6. A game as in claim 1 comprising computer software distributed across a computer network and supporting real-time interaction between networked computers, each with monitor and graphical human-to-computer interface, wherein game playing-piece control would include a keyboard and a hand-held pointer device.

7. A game as in claim 6 wherein
(A) there is depiction of said game board on said computer monitor with said hand-held pointer device control over the game board area and closeness to area viewed, near views displaying smaller areas with larger said game markers and distant views displaying larger areas with smaller game markers;
(B) the multiplicity of the game boards tessellated, with each game beginning with a minimal number of players with said home stations for each game board, is limited only by the computer resources required to support multiple boards each with their multiple players;
(C) the game view on each monitor has icons used in conjunction with the pointer device allowing a player to display their said parameter display and home station contents or the parameter display and home station contents of any selected adversary player;
(D) there is software-automated initialization of home station and said planet marker positions at a game's beginning and their advancement at each turn's completion;
(E) there is software-automated update of
(1) parameter display information, including the said speed and said fuel attributed to each spacecraft marker,
(2) home station contents when said spacecraft markers are advanced on a game board, and
(3) the status of said circuit markers changes, including their exchange for spacecraft markers;
(F) players move linearly and rotationally their spacecraft markers using the pointer device;
(G) there is displayed the probability that a spacecraft marker can said register an adversary spacecraft marker, and the success or failure of an attempted register is automatically calculated and displayed by said software;
(H) hypothetical-scenario views in which a player controlling said view advances game board markers a chosen number of turns,
wherein game board markers comprise home station and planet markers and spacecraft markers, either adversary or belonging to the player, with corresponding parameter display changes automatically displayed by software;
wherein once the player makes their decisions according to what they have learned with the hypothetical scenario, they return their said monitor view to the present-time game board and move their spacecraft markers accordingly;
(I) there is software-automated advancement of spacecraft markers designated to occupy circular orbits, parabolic orbits, paracircular orbits, meta-circular orbits, or meta-parabolic orbits;
(J) there is software-automated removal of under-utilized game boards in said multi-stellar games accompanied by software-automated re-assignment to active game boards of spacecraft markers on said removed game boards, both said removal and said re-assignment accomplished according to explicit game rule criteria; and
(K) there is software-automated calculation of spacecraft marker fleet values upon completion of a turn whose number is specified at a game beginning when that criteria is used to determine a game winner.

8. A game as in claim 4 comprising computer software distributed across a computer network and supporting real-time interaction between networked computers, each with monitor and graphical human-to-computer interface, wherein game playing-piece control would include a keyboard and a hand-held pointer device;
wherein said replica game board means and said present-time game board means are separate views on said computer monitor,
wherein said parameter display means is graphically represented on said computer monitor,
wherein said hypertime-jumping spacecraft marker commences its movements on the replica game board from the polygon corresponding to that it occupied on the turn it left the present-time game board,
wherein with respect to the replica game board the spacecraft marker interacts with said replica planet markers, resulting in said replica parameter display changes in that spacecraft marker's said replica speed and fuel,
wherein spacecraft markers hypertime-jumped to identical futures, represented by planet marker positions identically advanced, access identical replica game boards and may interact there identically to their interactions on the present-time game board,
wherein, if the hypertime-jumping spacecraft marker traverses the replica said central star figure, a replica said circuit marker is added to its replica parameter display,
wherein a player conceals from other players which replica game board to which they have advanced a spacecraft marker, and neither the replica game board nor replica parameter display changes for the hypertime-jumping spacecraft marker are viewable by other players unless such players also have hypertime-jumped a spacecraft marker to that same replica game board,
wherein the player reintroduces onto the present-time game board their hypertime-jumping spacecraft marker after a chosen number of turns, whose maximum is determined by the spacecraft marker's said class, commencing on the present-time game board polygon corresponding to the last it occupied on the replica game board,
wherein on the turn the spacecraft marker is reintroduced onto the present-time game board a view documenting its trajectory on the replica game board and corresponding replica parameter display changes is revealed to other players for their corroboration,
wherein spacecraft markers of varying class have varying capacity to access replica game boards representing varyingly distant futures, using the method of replica planet markers advanced from their present-time game board positions by varying increments of turns,
whereby the varied power of spacecraft of respective varied class to enter to and return from variedly distant futures is simulated.

9. A game as in claim 1 wherein said spacecraft marker classes are differentiated according to capabilities, comprising:
(A) number of said circuit markers a spacecraft marker can transfer between game board means areas using said player parameter display means, and
(B) probability of said registering another spacecraft marker.

10. A game as in claim 1 wherein said tessellation of a plurality of means of game boards has predetermined hyperspace-jump locations between which said spacecraft markers can move in one step regardless of the number of polygons between them composing one of said contiguous polygon paths;
whereby is simulated three dimensional euclidian space folded upon itself in a higher dimension and forming hyperspace-jump locations where those folds coincide;
wherein said hyperspace-jump locations comprise predetermined game board polygons and hyperspace-jump markers,
wherein said hyperspace-jump markers are positioned upon varying said game board means polygons.

11. A game as in claim 1 wherein some said game board means polygons are distinguished by indicia.

12. A game apparatus for use by a plurality of players that simulates sports-like competition between spacecraft navigating a stellar planetary gravitational field, and comprising:
a planar game board means whose center is the common center of a plurality of concentric rings of contiguous hexagons tessellated within and between rings,
whereby a stellar gravitational field, universally spherical in structure, is cross-sectionally simulated;
a plurality of spacecraft markers, each said spacecraft marker being distinguished according to player,
each said player's collection of spacecraft markers being distinguished according to class,
the player's spacecraft markers of particular said class being individually distinguished;
a plurality of home station markers providing locations where said spacecraft markers are entered upon and removed from said game board means;
said game board means having space between its edges and said outermost ring for placement of said home station markers;
a plurality of planet markers, each said planet marker advancing within one of said concentric rings according to predetermined pattern and synchronization;
a plurality of circuit markers, one said circuit marker representing one traversal of said game board central star figure by one said spacecraft marker;
a plurality of player parameter display means, one for each player, each said parameter display means comprising:
(a) spacecraft identity markers, each of which identifies one said spacecraft marker in play on the game board means, and
(b) for each said identity marker additional said display elements comprising speed markers and fuel markers,
whereby the speed and fuel of each spacecraft marker in play is disclosed for all players to know,
(c) for each said identity marker a plurality of said circuit markers, including one and none;
a navigation means, including player discretion, governing the interaction between said spacecraft markers, said central star figure, said contiguous paths of polygons, and said planet markers,
wherein a spacecraft marker trajectory, consisting of position and orientation upon the game board means, spacecraft marker speed, and spacecraft marker fuel, is altered with predetermined pattern and, according to other predetermined patterns, not altered;
a registering of one said spacecraft marker by another spacecraft marker in which the registering spacecraft marker causes the registered spacecraft marker's removal from the game board means,
whereby one spacecraft's laser-strike against the hull photo-receptor target of another is simulated;
a means for determining said registering comprising a frequency distribution over a set of numbers and a random function device generating said distribution;
said spacecraft marker classes differentiated according to capabilities, comprising:
(a) number of said circuit markers a spacecraft marker can transfer between game board means areas using said player parameter display means, and
(b) probability of said registering another spacecraft marker;
a criteria for determining a game winner comprising the winner either
(a) eliminating opponent said spacecraft markers from said game board means
or
(b) the winner accumulating the most valuable set of spacecraft markers, measured in said circuit marker exchange units, after a number of player turns agreed upon at a game's beginning.

13. A game as in claim 12 comprising additionally a hypertime-jump means
wherein a player can advance a said spacecraft marker from its polygon position on said game board means onto the analogous polygon position on a replica means of the game board means, on which said replica means the said planet markers have been advanced an incremented number of positions with respect to those positions on the former, initial game board means, thereby defining the former game board means as present-time and said replica game board means as future time-shifted,
wherein the spacecraft marker advanced to the replica game board means can return to said present-time game board means,
wherein on the replica game board means the spacecraft marker advances according to the same said navigation means component that governs its motion on the present-time game board means,
wherein a replica said parameter display means is formed for that specific spacecraft marker with replica said speed and fuel notation, thereby defining the parameter display means corresponding to the present-time game board means as the present-time parameter display means,
wherein the spacecraft marker can interact with replica planet markers with corresponding said replica parameter display means changes to its replica speed and fuel,
wherein the spacecraft marker can traverse the replica game board means' said central star figure and gain a replica said circuit marker for its replica parameter display means which said replica circuit marker is transferred to the present-time parameter display means when the spacecraft marker returns to the present-time game board means,
wherein said spacecraft marker classes are differentiated according to capability to access replica means of game boards time-shifted into varyingly distant future times represented by advancements of the positions of the replica planet markers,
whereby spacecraft travel to varied future times and return to the present times of their embarkation is simulated.

14. A game as in claim 13
wherein said hypertime-jumping spacecraft marker returns to said present-time game board on the polygon corresponding to the last polygon it occupied on said replica game board means,
wherein other players have knowledge neither of the spacecraft marker's trajectory on the replica game board means nor of its said replica parameter display means,
wherein on the turn the spacecraft marker returns to the present-time game board means said knowledge of its trajectory and replica parameter display means is revealed to other players.

15. A game as in claim 14 wherein said hypertime-jump means comprises a line drawing replicating in concise manner said present-time game board means and an instrument to notate on that replica game board means said spacecraft marker moves and said planet marker advances,
wherein said line drawing and said instrument to mark thereon comprises lines printed on paper and pencil or comprises a board with the replica line drawing indelibly printed thereon and ink that is erasable with respect to the material fabricating said board.

16. A game as in claim 12 comprising computer software distributed across a computer network and supporting real-time interaction between networked computers, each with monitor and graphical human-to-computer interface, wherein game playing-piece control would include a keyboard and a hand-held pointer device, wherein
(A) there is software-automated initialization of said planet marker positions at a game's beginning;
(B) there is software-automated advancement of said spacecraft markers designated to occupy circular and parabolic orbits;
(C) there is depiction of said game board on said computer monitor with said hand-held pointer device control over the game board area and closeness to area viewed, near views displaying smaller areas with larger said game markers and distant views displaying larger areas with smaller game markers;
(D) the game view on each monitor has icons used in conjunction with the pointer device allowing a player to display their said parameter display and home station contents or display the parameter display and home station contents of any selected adversary player;
(E) there is software-automated update of
(1) parameter display information, including the said speed and said fuel attributed to each spacecraft marker,
(2) home station contents when said spacecraft markers are advanced on a game board, and
(3) the status of said circuit markers changes, including their exchange for spacecraft markers;
(F) players move linearly and rotationally their spacecraft markers using the pointer device;
(G) there is displayed the probability that a spacecraft marker can said register an adversary spacecraft marker, and the success or failure of an attempted register is automatically calculated and displayed by said software;
(H) hypothetical-scenario views in which a player controlling said view advances game board markers a chosen number of turns,
wherein game board markers comprise planet markers and spacecraft markers, either adversary or belonging to the player, with corresponding parameter display changes automatically displayed by software;
wherein once the player makes their decisions according to what they have learned with the hypothetical scenario, they return their said monitor view to the present-time game board and move their spacecraft markers accordingly; and
(I) there is software-automated calculation of spacecraft marker fleet values upon completion of a turn whose number is specified at a game beginning when that criteria is used to determine a game winner.

17. A game as in claim 14 comprising computer software distributed across a computer network and supporting real-time interaction between networked computers, each with monitor and graphical human-to-computer interface, wherein game playing-piece control would include a keyboard and a hand-held pointer device;
wherein said replica game board means and said present-time game board means are separate views on said computer monitor,
wherein said parameter display means is graphically represented on said computer monitor,
wherein said hypertime-jumping spacecraft marker commences its movements on the replica game board from the polygon corresponding to that it occupied on the turn it left the present-time game board,
wherein with respect to the replica game board the spacecraft marker interacts with said replica planet markers, resulting in said replica parameter display changes in that spacecraft marker's said replica speed and fuel,
wherein spacecraft markers hypertime-jumped to identical futures, represented by planet marker positions identically advanced, access identical replica game boards and may interact there identically to their interactions on the present-time game board,
wherein, if the hypertime-jumping spacecraft marker traverses the replica said central star figure, a replica said circuit marker is added to its replica parameter display,
wherein a player conceals from other players which replica game board to which they have advanced a spacecraft marker, and neither the replica game board nor replica parameter display changes for the hypertime-jumping spacecraft marker are viewable by other players unless such players also have hypertime-jumped a spacecraft marker to that same replica game board,
wherein the player reintroduces onto the present-time game board their hypertime-jumping spacecraft marker after a chosen number of turns, whose maximum is determined by the spacecraft marker's said class, commencing on the present-time game board polygon corresponding to the last it occupied on the replica game board,
wherein on the turn the spacecraft marker is reintroduced onto the present-time game board a view documenting its trajectory on the replica game board and corresponding replica parameter display changes is revealed to other players for their corroboration,
wherein spacecraft markers of varying class have varying capacity to access replica game boards representing varyingly distant futures, using the method of replica planet markers advanced from their present-time game board positions by varying increments of turns,
whereby the varied power of spacecraft of respective varied class to enter to and return from variedly distant futures is simulated.

18. A game apparatus for use by a plurality of players that simulates spacecraft navigation of a stellar planetary system and that system's economic development subordinate to a universal moral dynamic effecting synergy between each player's advancement of their own economic interests and their sacrifices for the advancements of other players, and comprising:
a planar game board means whose center is the common center of a plurality of concentric rings of contiguous hexagons tessellated within and between rings,
whereby a stellar gravitational field, universally spherical in structure, is cross-sectionally simulated;
a plurality of planet markers, each said planet marker advancing within one of said concentric rings according to predetermined pattern and synchronization;
a plurality of external planet markers, one for each said planet marker,
each said external planet marker being associated with a distinct said planet marker and that planet marker's distinct said resource marker,
whereby a stationary platform is obtained representing a planet marker revolving upon said game board means;
a plurality of spacecraft markers, each said spacecraft marker being distinguished according to player,
each said player's collection of spacecraft markers being distinguished according to class,
the player's spacecraft markers of particular said class being individually distinguished;
said game board means having non-tessellated space between its outermost said ring of hexagons and its edges for placement of said external planet markers,
wherein the external planet markers' tessellation with or proximity to the said outermost ring identifies those places where said spacecraft markers enter and leave the game board means;
a plurality of planet resource markers, each said resource marker being distinguished according to resource variety;
a plurality of player parameter display means, one for each player, each said parameter display means comprising:
(a) spacecraft identity markers, each of which identifies one said spacecraft marker in play on the game board means, and
(b) for each said identity marker additional said display elements comprising speed markers, fuel markers, resource markers, and population markers,
whereby the speed, fuel, resource cargo, and passenger compliment of each spacecraft marker in play is disclosed for all players to know;
a navigation means, including player discretion, governing the interaction between said spacecraft markers, said central star figure, said contiguous paths of polygons, and said planet markers,
wherein a spacecraft marker trajectory, consisting of position and orientation upon the game board means, spacecraft marker speed, and spacecraft marker fuel, is altered with predetermined pattern and, according to other predetermined patterns, not altered;
a plurality of society markers, each said society marker being distinguished according to society complexity;
a plurality of knowledge markers, each said knowledge marker being distinguished according to varied knowledge category and level for each said category;
a plurality of population markers, each said population marker representing one population unit;
a means for representing a plurality of instructions, each said instruction designating a distinct impairment of specific said classes of spacecraft markers and society markers of specific said complexity,
each said impairment coupled with a game rule requiring that, in the circumstance that a player receives one of said instructions, other players, when predetermined criteria are fulfilled, must decide whether to use their own game markers comprising spacecraft markers, society markers, said resource markers, said population markers, and said knowledge markers to release said instruction receiving player from impairment of their game marker,
whereby one player chooses to assist another;
a plurality of player grace markers, each said grace marker being distinguished according to player grace level,
each player's grace level being determined by their said decisions to assist and not assist other players,
whereby is simulated the morality accruing to an interstellar civilization from its member's collective decisions regarding the members of other civilizations;
said player parameter display means further comprising said grace markers and said knowledge markers;
a means for determining whether a player receives said impairment instruction comprising a frequency distribution over a set of numbers and a random function device generating said distribution;
said knowledge markers of different category and level for each category forming a knowledge tuple for each player, and each said impairment instruction including said knowledge tuple to which the instruction receiving player compares their knowledge tuple to determine whether each knowledge category level constituting their tuple satisfies predetermined conditions with respect to the impairment instruction's tuple's corresponding knowledge category level, said satisfaction of predetermined conditions for all tuple components resulting in the player avoiding the impairment instruction,
whereby is simulated a society's use of knowledge to preserve itself by preparing for and thereby avoiding destructive events and by recovering from destructive events;
said spacecraft markers, society markers, resource markers, population markers, and knowledge category levels constitute player capital varieties and are exchanged between players according to practices sometimes fixed by player agreement at a game's beginning, sometimes negotiated freely between players at the time of exchange, and sometimes fixed by players having achieved on one or more said external planet markers society markers of predetermined complexity,
whereby is simulated capital markets;
each said society marker requiring for its establishment on one said external planet marker the exchange of said capital varieties in combinations unique for each said society marker complexity variety;
each said society marker after its establishment on said external planet marker causing to be distributed to its player on predetermined play rounds said resource markers and said population markers and said knowledge level increments in some mix of said knowledge categories,
whereby is simulated population growth and societies' productions of materials and knowledge;
a population homeostasis means wherein the accumulation of said population markers beyond quantities specified for said society markers of said complexity variety causes the decrement of a player's said grace level according to predetermined conditions and with predetermined consequence,
whereby is simulated population homeostasis in which economic expansion requires balanced population growth but surplus population, implying unemployable population, causes increased social unrest and discord, thereby diminishing a society's health and prospect;
a mathematical formula yielding a player score as function of player grace level and player knowledge level, wherein the player score determines the game winner,
whereby is simulated compassion's amplification of knowledge to establish the supreme society.

19. A game as in claim 18
wherein each said external planet marker is partitioned by indicia into areas associated with each player,
wherein each said partitioned area is used to display the player's said society markers, said resource markers, and said population markers associated with the external planet marker,
whereby commerce transacted on particular planets is simulated;

20. A game as in claim 18 wherein some said game board means polygons are distinguished by indicia.

21. A game as in claim 18 implemented using computer software distributed across a computer network and supporting real-time interaction between networked computers, each with monitor and graphical human-to-computer interfaces, wherein game playing-piece control includes a keyboard and a hand-held pointer device.

22. A game as in claim 21 wherein
(A) there is depiction of said game board on said computer monitor with said hand-held pointer device control over the game board area and closeness to area viewed, near views displaying smaller areas with larger said game markers and distant views displaying larger areas with smaller game markers;
(B) the game view on each monitor has icons used in conjunction with the pointer device allowing a player to display their said parameter display and home station contents or display the parameter display and home station contents of any selected competing player;
(C) there is software-automated initialization of said planet marker positions at a game's beginning and their advancement at each turn's completion;
(D) said grace process is software-automated, including automation of
(1) the process incorporating a player's said grace level and said random function device which determines at each turn's beginning whether a player is said catastrophe and/or entropy sanctioned, meaning they are required to draw catastrophe and/or entropy cards,
(2) graphical analogues of the catastrophe and entropy cards, which said analogues include those cards' information,
(3) game board said grace gain and grace loss areas which a player must consider after a competing player is catastrophe and/or entropy sanctioned, which areas are highlighted on a monitor by some combination of changed light intensity and color,
(4) display of the success or failure of a player's said knowledge category levels to mitigate a catastrophe and/or entropy sanction,
(5) recording each player's choice to assist or not assist a catastrophe and/or entropy sanctioned player's said impaired game markers and determination of such former player's actual fulfillment of that assistance,
(6) impairment of a catastrophe and/or entropy sanctioned player's game markers or successful nullification of that impairment by another assisting player,
(7) hypothetical scenario generation enabling a player to
(a) display future turn said planet marker positions,
(b) advance according to that player's discretion their own or competing players' markers, and
(c) choose specific catastrophe and/or entropy scenarios with those scenario's corresponding grace gain and grace loss said screen highlights, without affecting the actual game board scenario, to which the player returns after making decisions according to that said hypothetical scenario;
(E) there is software automation of other fundamental game processes, comprising
(1) the said knowledge marker mechanisms, including for each player the said cyclical distribution of knowledge category points by society markers and those points' increments of the respective three knowledge category levels and those levels' display on their player's parameter display,
(2) the said society marker mechanisms, including
(a) the establishment of society markers on said external planet markers by (a1) transport and accumulation of the said resource marker specific varieties and (a2) exchange of capital and
(b) society markers' cyclical distributions according to planet marker positions of resource and population markers and knowledge category points, and
(3) the external planet marker mechanisms, including each's display for each player with at least one society marker thereon of the resource markers and population markers accruing to that player;
(F) there is software-automated update of
(1) parameter display information, including the said speed and fuel attributed to each spacecraft marker, when the spacecraft marker is advanced on a game board and
(2) said home station contents;
(G) players move their spacecraft markers with respect to a game board, including linear and rotational movements, using a hand-held pointer device;
(H) there is software-automated tabular display of player capital;
(I) there is software-automated calculation and display for each player of said population homeostasis means parameters, including current turn population for individual society markers and for each player the total population for all of their society markers and corresponding projected growth for specified future turns for individual and total society markers, and for those projected populations the corresponding projected influences on grace level, which influence derives from said incorporation of population totals into the random selection of an entropy sanction; and
(J) there is software-automated calculation and display of the said player duplex score.

23. A game as in claim 18 wherein said player parameter display means is an array easel comprised of ledges upon which markers may be placed;
wherein for each spacecraft marker in play upon the game board means there is, for placement upon the ledges of said array easel,
(A) a marker identifying said spacecraft marker using color matching the spacecraft marker's class and using a numeral identical to that of the spacecraft marker's numeral,
(B) a marker indicating with numeral said spacecraft marker's speed, wherein a spacecraft marker's speed can be changed by exchanging its said speed marker having one numeral with a speed marker having a different numeral, and
(C) a marker indicating with numeral said spacecraft marker's fuel, wherein a spacecraft marker's fuel can be changed by exchanging its said fuel marker having one numeral with a fuel marker having a different numeral;
wherein a spacecraft marker's acquisition of fuel from a fuel resource planet is represented by increment of the numeral of its fuel marker;
whereby is simulated changes in spacecraft speed for any reason, expenditure of spacecraft fuel to adjust its speed and/or direction, and spacecraft refueling.

24. A game as in claim 18 wherein said player parameter display means is an array easel comprised of ledges upon which markers may be placed
wherein said grace markers are distinguished by color and indicia and shaped to fit on a ledge of said array and wherein each said grace level is distinguished by a numeral;
wherein said knowledge markers are shaped to fit on said array and wherein said knowledge markers of varied category are distinguished by color and indicia and wherein said knowledge level for each said category is distinguished by a numeral;
wherein said resource markers are shaped to fit on said array ledges and within said player partitions of said external planet markers and wherein said varied resource markers are distinguished by color and indicia;
wherein said varied complexity society markers are distinguished by attributes comprising shape, color, and indicia and wherein said society markers are scaled to fit within said player partitions of said external society markers;
wherein said planet markers are disks distinguished by attributes comprising size and indicia according to the respective closeness of the ring within which each advances to that ring's said common center.

25. A game as in claim 18 wherein, for said population homeostasis means, said grace level decrement, required in the event of said population marker accumulation beyond specified quantities, applies only to said entropy card selection random process for the specific turn for which the player's said population marker surplus exists, and said grace marker on the player's parameter display means is not affected,
wherein said decrement amount is determined by a formula incorporating the numbers of said surplus population markers for each said external planet marker and the number of such external planet markers for which such surplus exists.

26. A game as in claim 18 wherein said spacecraft marker classes are differentiated according to capabilities, comprising:
(A) number of said resource markers and said population markers a spacecraft marker can transfer between game board means areas using said player parameter display means,
whereby spacecraft cargo and passenger capacities are simulated,
(B) immunity from said instructions of impairment,
(C) projection of said immunity from impairment over other spacecraft markers and society markers.

27. A game as in claim 18 wherein the type one and type two correspondences governing the frequency of said entropy and catastrophe sanctions may be adjusted such that either sanction or both sanctions are either more or less probable to occur;
whereby there is simulated a universal moral dynamic that can be parameterized in either the clement or punitive direction.
